(19) United States
(12) Patent Application Publication
(10) Pub. No.: US 2019/0259466 A1
(43) Pub. Date: Aug. 22, 2019

(54) SEPARABLE ROBUST CODING

(71) Applicant: Bar-Ilan University, Ramat-Gan (IL)

(72) Inventors: Tallia LEVY, RaAnana (IL); Yaniv Moshe BODNER, Givat Shmuel (IL); Hila RABII, Holon (IL); Yaara NEUMEIER, Givat Shmuel (IL); Osnat KEREN, Rosh HaAyin (IL)

(73) Assignee: Bar-Ilan University, Ramat-Gan (IL)

(21) Appl. No.: 16/334,081

(22) PCT Filed: Sep. 19, 2017
(86) PCT No.: PCT/IL2017/051058

§ 371 Date: Mar. 18, 2019

Related U.S. Application Data
(60) Provisional application No. 62/397,392, filed on Sep. 21, 2016.

(51) Int. Cl. G11C 29/52; G06F 11/36; G06F 21/72; G06F 21/75; H03K 19/003; H04L 9/00

(52) U.S. Cl. CPC G11C 29/52; G06F 11/3612; G06F 21/72; H04L 2209/34; H03K 19/00392; H04L 9/004; G06F 21/75

(57) ABSTRACT

A method for detecting errors is performed on a data string which includes an information portion and a redundancy portion. The information portion includes two or more sub-strings. The method includes generating respective redundancy words for each sub-string by encoding each sub-string with a separable robust code. A composite redundancy word is generated from respective redundancy words. An error is flagged when the redundancy portion of said data string differs from the composite redundancy word.

### FIELD AND BACKGROUND OF THE INVENTION

The present invention, in some embodiments thereof, relates to separable robust coding and, more particularly, but not exclusively, to a separable robust code for detecting errors in data strings.

Hardware systems are vulnerable to fault injection attacks. In fault injection attacks an adversary tampers with the hardware to modify the outputs [1,2], which changes the behavior of the device. Fault injection may be carried out using different physical methods, such as variations on voltage, external clock, white light, laser, etc. Some injections methods, such as jamming, especially target memories.

Some known protection methods against fault injection attacks include tamper protection and hardware duplication, however they are less applicable in small, mobile lightweight devices.

Another approach to detecting fault injection is the use of security oriented error detecting codes, which can detect any error with some probability. In error detecting codes the injected fault manifests as an additive error and can be detected regardless of the physical injection method. Hence, error detecting codes can protect these devices from some threats.

Security oriented codes are usually systematic because the validity of the codeword can be verified while simultaneously processing the information portion. In systematic codes every codeword is a q-ary vector of length n=k+r of the form C={c=(x, u(x))} where x consists of k information symbols over [symbol] _{q}=GF(q) and u consists of r redundancy symbols over [symbol] _{q}=GF(q).

It is generally assumed that an attacker can inject any error it chooses. This is why the effectiveness of security oriented codes is measured in terms of their maximal (i.e. worst) error masking probability. A security oriented code may have a deterministic encoder [3, 4, 5, 6] or incorporate randomness [7, 8]. The error detection capabilities of codes with random-encoding depend on the entropy of the random portion. However, the hardware implementation of a true Random Number Generator (RNG) is expensive and difficult, making them less suitable for low-cost devices. Moreover, the RNG must be shielded from fault injection attacks which could neutralize it. When properly designed, codes with deterministic encoding may be more effective than random codes with the same rate [9].

### SUMMARY OF THE INVENTION

Embodiments of the invention present a code-plus-code coding scheme (also denoted herein CpC) that may be used to construct robust codes for any (k,r) pair, where k is the number of information symbols and r is the number of redundancy symbols in the code word. The CpC code is itself a separable robust code and is able to detect any error with nonzero probability, making it an effective code for detecting fault injection and jamming attacks.

The CpC code is constructed from l robust ground codes, optionally with different information and/or redundancy portion sizes. CpC codes with low implementation complexity may be designed for any code rate. Optionally, the CpC is implemented with an optimal set of ground codes which are selected by an optimization algorithm such as Algorithm 2 presented below.

According to an aspect of some embodiments of the present invention there is provided a method for detecting errors in a data string. The data string includes an information portion and a redundancy portion. The information portion includes at least two sub-strings. The method is performed in a hardware device by:
generating a first redundancy word by encoding a first one of the sub-strings with a first separable robust code;
generating a second redundancy word by encoding a second one of the sub-strings with a second separable robust code;
generating a composite redundancy word from the first and second redundancy words; and
flagging an error when the redundancy portion of the data string differs from the composite redundancy word.

According to some embodiments of the invention, generating a composite redundancy word includes addition over a finite field of the first and second redundancy words.

According to some embodiments of the invention, the first and second redundancy words have equal length.

According to some embodiments of the invention, only one of the first and second separable robust codes is a quadratic sum (QS).

According to some embodiments of the invention, the first and second redundancy words have a different length.

According to some embodiments of the invention, the composite redundancy word is further generated from at least one additional redundancy word, where each additional redundancy word is generated by encoding a further one of the sub-strings with a separable robust code.

According to some embodiments of the invention, the first separable robust code and the second separable robust code are the same code.

According to some embodiments of the invention, the first separable robust code and the second separable robust code are different codes.

According to some embodiments of the invention, the method for detecting errors in a data string further includes outputting a data word in accordance with an error combatance logic in response to flagging an error.

According to some embodiments of the invention, at least one of the first and second separable robust codes is an error-correction code.

According to some embodiments of the invention, the hardware device includes a logic gates configured to perform the generating and the flagging.

According to some embodiments of the invention, the hardware device includes at least one of: a memory, a logic circuit, an integrated circuit (IC), a programmable logic element or a communication device.

According to some embodiments of the invention, the hardware device includes at least one non-transitory computer readable storage medium storing instructions and at least one processor configured to execute the instructions to perform the generating and the flagging.

According to some embodiments of the invention, the method for detecting errors in a data string further includes reading the data string from a memory.

According to some embodiments of the invention, the method for detecting errors in a data string further includes reading the data string from a register.

According to some embodiments of the invention, the method for detecting errors in a data string further includes extracting the data string from a data signal.

According to some embodiments of the invention, the method for detecting errors in a data string further includes receiving the data string through a data interface.

According to some embodiments of the invention, the method for detecting errors in a data string further includes reading the data string from a data bus in a logic circuit.

According to some embodiments of the invention, the method for detecting errors in a data string further includes obtaining the data string from nodes in a logic circuit.

According to an aspect of some embodiments of the present invention there is provided a checker for detecting errors in a data string. The data string includes an information portion and a redundancy portion. The information portion includes at least two sub-strings. The checker includes a redundancy generator and an error detector. The redundancy generator generates a first redundancy word by encoding a first one of the sub-strings with a first separable robust code, generates a second redundancy word by encoding a second one of the sub-strings with a second separable robust code and generates a composite redundancy word from the first and second redundancy words. The error detector flags an error when the redundancy portion of the data string differs from the composite redundancy word.

According to some embodiments of the invention, the composite redundancy word is further generated from at least one additional redundancy word, each additional redundancy word being generated by encoding one of the sub-strings with a separable robust code.

According to some embodiments of the invention, the composite redundancy word is generated by addition over a finite field of the first and second redundancy words.

According to some embodiments of the invention, the first and second redundancy words have equal length.

According to some embodiments of the invention, only one of the first and second separable robust codes is a quadratic sum (QS) code.

According to some embodiments of the invention, the first and second redundancy words have a different length.

According to some embodiments of the invention, the first separable robust code and the second separable robust code are the same code.

According to some embodiments of the invention, the first separable robust code and the second separable robust code are different codes.

According to some embodiments of the invention the checker outputs a data word in accordance with an error combatance logic in response to the flagged error.

According to some embodiments of the invention, the checker includes a plurality of logic gates in a logic circuit.

According to some embodiments of the invention, the checker is integrated into a hardware device. According to further embodiments of the invention, the hardware device includes at least one of: a memory, a logic circuit, an IC, a programmable logic element or a communication device.

According to some embodiments of the invention, the checker further includes: at least one non-transitory computer readable storage medium storing instructions and at least one processor configured to execute the instructions to perform the generating and the flagging.

According to some embodiments of the invention, the checker performs at least one of:
reading the data string from a memory;
reading the data string from a register;
extracting the data string from a data signal;
receiving the data string through a data interface;
obtaining the data string from nodes in a logic circuit; and
reading the data string from a data bus in a logic circuit.

According to an aspect of some embodiments of the present invention there is provided a method of encoding information strings. The method is performed in a hardware device by:
inputting an information string comprising at least two sub-strings;
associating the sub-strings with codewords of respective separable robust codes, each of the associated codewords comprising a respective information word and a respective redundancy word; and
outputting a concatenated-codeword comprising an information portion comprising a concatenation of the respective information words and a redundancy portion generated from the respective redundancy words.

According to some embodiments of the invention, the redundancy portion is generated by addition over a finite field of the respective redundancy words within the codewords.

According to some embodiments of the invention, at least one of the separable robust codes is a non-quadratic sum (QS) code.

According to some embodiments of the invention, at least two of the redundancy words have a different length.

According to some embodiments of the invention, the information string is separated into two sub-strings.

According to some embodiments of the invention, the hardware device includes a plurality of logic gates configured to perform the inputting, the associating and the outputting.

According to some embodiments of the invention, the hardware device includes at least one of: a memory, a logic circuit, an integrated circuit (IC), a programmable logic element or a communication device.

According to some embodiments of the invention, the hardware device includes at least one non-transitory computer readable storage medium storing instructions and at least one processor configured to execute the instructions to perform the generating and the outputting.

According to some embodiments of the invention, the method of encoding information strings further includes at least one of:
reading the information string from a memory;
reading the data string from a register;
extracting the information string from a data signal;
receiving the information string through a data interface;
obtaining the data string from nodes in a logic circuit; and
reading the information string from a data bus in a logic circuit.

According to an aspect of some embodiments of the present invention there is provided an encoder which includes a codeword associator and a codeword outputter. The codeword associator separates an information string into at least two sub-strings, associates a first one of the sub-strings with a codeword of a first separable robust code, the codeword of the first separable robust code comprising a respective information word and a respective redundancy word, associates a second one of the sub-strings with a codeword of a second separable robust code, the codeword of the second separable robust code comprising a respective information word and a respective redundancy word. The codeword outputter outputs a concatenated-codeword an information portion which is formed as a concatenation of the information words and a redundancy portion generated from the redundancy words.

According to some embodiments of the invention, the redundancy portion is generated by addition over a finite field of the respective redundancy words within the codewords.

According to some embodiments of the invention, the information string is separated into two sub-strings.

According to some embodiments of the invention, only one of the first and second separable robust codes is a quadratic sum (QS) code.

According to some embodiments of the invention, the redundancy words have a different length.

According to some embodiments of the invention, the encoder includes logic gates in a logic circuit.

According to some embodiments of the invention, the encoder is integrated into a hardware device.

According to some embodiments of the invention, the hardware device includes at least one of: a memory, a logic circuit, an IC, a programmable logic element or a communication device.

According to some embodiments of the invention, the encoder further includes: at least one non-transitory computer readable storage medium storing instructions and at least one processor configured to execute the instructions to perform the separating, associating and outputting.

According to some embodiments of the invention, the encoder additionally performs at least one of:
reading the information string from a memory;
reading the data string from a register;
extracting the information string from a data signal;
receiving the information string through a data interface;
obtaining the information string from nodes in a logic circuit; and
reading the information string from a data bus in a logic circuit.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified flowchart of a method for detecting errors in a data string, according to embodiments of the invention;

FIG. 1B illustrates an exemplary data string structure;

FIG. 2 is a simplified block diagram of a checker for detecting errors in a data string, according to embodiments of the invention;

FIG. 3 is a simplified flowchart of a method of encoding information strings, according to embodiments of the invention;

FIG. 4 is a simplified block diagram of an encoder according embodiments of the invention;

FIG. 5A is a simplified block diagram of a hardware system which is protected by a CpC code, according to exemplary embodiments of the invention;

FIG. 5B is a simplified block diagram of a checker, according to exemplary embodiments of the invention;

FIG. 5C is a simplified block diagram of an encoder, according to exemplary embodiments of the invention;

FIG. 6 is a schematic illustration of an exemplary encoder of a QS code;

FIG. 7 is a schematic illustration of an exemplary encoder of a TS code;

FIG. 8 is a schematic illustration of an exemplary encoder of a PC code;

FIG. 9 is an example of a finite field multiplication in [symbol] ₂³;

FIG. 10 is an example of a punctured finite field multiplication in [symbol] ₂³ with a puncturing set Sₚ; and

FIG. 11 is an example of a shortened finite field multiplier in [symbol] ₂³.

### DESCRIPTION OF SPECIFIC EMBODIMENTS OF THE INVENTION

The present invention, in some embodiments thereof, relates to separable robust coding and, more particularly, but not exclusively, to a separable robust code for detecting errors in data strings.

A CpC code is a type of separable robust code (denoted herein a CpC code) that may be used for checking an input data string for errors to determine whether the data string is a legal CpC codeword. The information portion of the input data string is subdivided into sub-strings. Each sub-string is encoded with a respective separable robust code. The respective redundancy strings are used to generate a composite redundancy word, optionally by addition over a finite field of the respective redundancy words of the sub-strings forming the information portion. If the composite redundancy word differs from the redundancy portion of the data string, an error is detected and flagged. If the data string is a legal CpC codeword it is known that no errors are detected in the information portion of the CpC codeword.

In some embodiments, a CpC code is used to encode an information string. The information string to be encoded is sub-divided into two or more sub-strings. A respective separable robust code is used to encode each sub-string. Alternately or additionally one or more of the sub-strings is associated in a different manner with a legal codeword of the respective code as described below. Each sub-string's associated codeword includes an information portion (denoted herein an information word) and a redundancy portion (denoted herein a redundancy word). The information portion of the CpC codeword is formed by concatenating the respective information words. The redundancy portion of the CpC codeword is generated from the respective redundancy words, optionally by addition over a finite field of the respective redundancy words. Optionally, the addition over a finite field is implemented using XOR and/or XNOR operations (as it is known that: x XNOR y=x XOR y XOR 1).

The information string is not necessarily of maximal entropy. Some or all of the information string may be encoded and/or otherwise processed prior to being encoded with the CpC code. Alternately or additionally, the CpC output code word may be further encoded and/or otherwise processed.

Optionally, the data in the information string is input from a single source. Alternately, the data in the information string is provided by multiple sources and then combined into a single string. Different sources of information may provide data with different respective encodings and/or non-encoded data.

Exemplary embodiments of the invention combine different separable robust codes within for error detection or for encoding an information string. The separable codes may be of different types and/or have different lengths.

Embodiments of the invention may utilize one or more of the following types of separable robust codes:

a) Quadratic Sum (QS) code [3];

b) Punctured Square (PS) code [4,11];

c) Punctured Cubic (PC) code [5];

d) Shortened Quadratic Sum (sQS) code [14];

e) Triple Sum (TS) code [14];

f) Triple Quadratic Sum (tQS) code [14].

Using more than one type of ground code for the CpC enables easy design of codes with desired properties. These properties include but are not limited to:

a) Code dimension;

b) The length of the redundancy portion (r);

c) The maximal error masking probability (Q̅); and

d) Low implementation cost.

Quadratic-Sum (QS) codes, for example, have relatively low implementation cost in hardware, but are limited to a dimension which is an even multiple of the number of redundancy symbols. Optionally, not all of the robust separable codes used for CpC encoding and/or error detection are QS codes. Further optionally, only one of the robust separable codes is a QS code.

In some portions of the description, particularly those presenting an analysis and optimization embodiments of the CpC, the codes used as the basic “building blocks” for constructing a CpC are denoted “ground codes”.

It is envisioned that new separable robust ground codes will be developed in the future, and the scope of the CpC encoder and CpC checker described herein is intended to encompass all such separable robust ground codes.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

For clarity, some embodiments presented herein are described for the non-limiting embodiment of a data string with an information portion subdivided into two sub-strings. As will be appreciated by a person of skill in the art, other embodiments of the method for detecting errors and/or checker and/or method of encoding and/or encoder may be generalized straightforwardly for information portions subdivided into two or more sub-strings.

### 1. Method of Detecting Errors

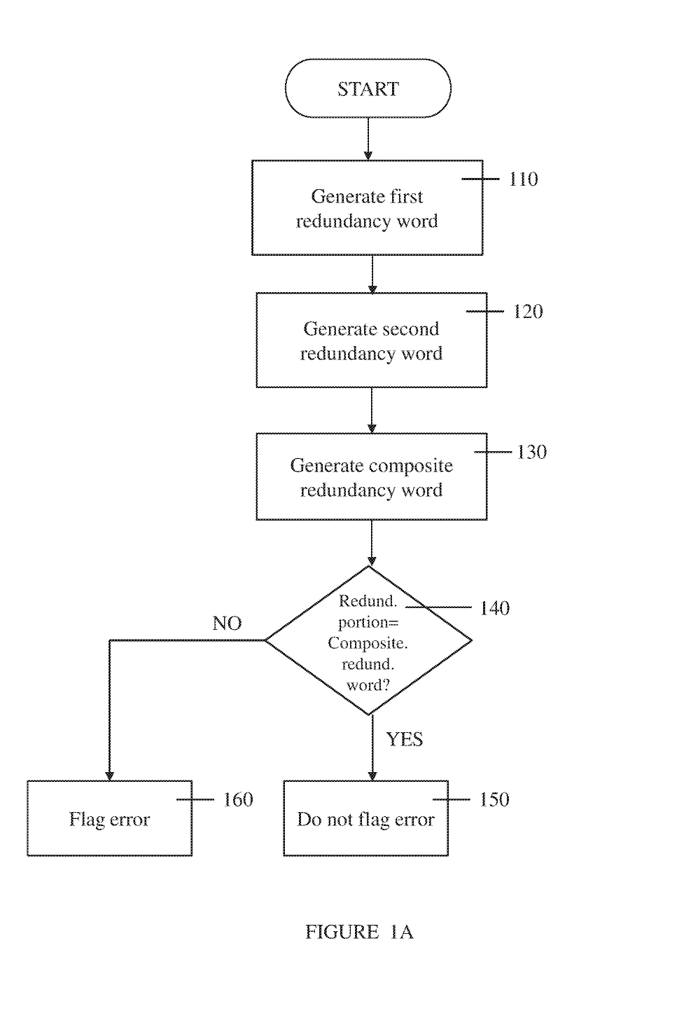

Reference is now made to FIG. 1A, which is a simplified flowchart of a method for detecting errors in a data string, according to embodiments of the invention. The data string includes an information portion and a redundancy portion (as found in codewords of separable robust codes). The information portion contains at least two sub-strings. Optionally, the method is performed by a hardware device, as described in more detail below.

As used herein the term “redundancy portion” is the redundancy segment in the input string (i.e. the data string for error detection embodiments or the information string for encoding embodiment).

As used herein the term “redundancy word” is the redundancy segment in codeword generated from a sub-string of a data string (in method for detecting errors and checker embodiments) or associated with a sub-string of an information string (in method of encoding and encoder embodiments).

In 110 a first redundancy word is generated by encoding one of the sub-strings with a first separable robust code. In 120 a second redundancy word is generated by encoding the second sub-string with a second separable robust code. For clarity, FIG. 1A shows a non-limiting embodiment in which 110 and 120 are performed in series (i.e. the first sub-string is encoded and then the second sub-string is encoded). In other embodiments, the two sub-strings are encoded in parallel. Furthermore, in embodiments with involving more than two sub-strings, some or all of the sub-strings may be encoded in parallel, or, alternately, all the sub-strings may be encoded serially.

Optionally, the method includes the preliminary step (not shown) of sub-dividing the information portion into sub-strings.

FIG. 1B illustrates an exemplary data string structure. Data string 170 includes redundancy portion 180 and information portion 190. Information portion 190 is subdivided into n sub-strings, 195.1-195.1.

Optionally, the first and second redundancy words have equal length. Alternately, the first and second redundancy words have different lengths.

Optionally, the separable robust codes used to encode the sub-strings are the same type of code. Alternately, some or all of the separable robust codes used to encode the respective sub-strings are different types of codes.

Optionally, separable robust codes used to implement a CpC include, but are not limited to, least one of:

a) Quadratic-Sum (QS) code;

b) Punctured Square (PS) code;

c) Punctured Cubic (PC) code;

d) Shortened Quadratic Sum (sQS) code;

e) Triple Sum (TS) code; and

f) Triple Quadratic Sum (tQS) code.

Optionally, only one of the separable robust codes used to implement the CpC is a QS code.

Optionally, embodiments of the method include error correction. Further optionally, one or more of the separable robust codes is an error-correction code.

In 130 a composite redundancy word is generated from the sub-strings' redundancy words. Optionally the composite redundancy word is generated by addition of the sub-strings' redundancy words over a finite field.

In 140, the redundancy portion in the data string is compared to the composite redundancy word. If they are the same, in 150 no error is detected (i.e. flagged). If the data string's redundancy portion differs from the composite redundancy word, in 160 an error is flagged.

Optionally, the information portion includes more than two sub-strings. A redundancy word is generated for each of the sub-strings using a respective separable robust code, and the composite redundancy word is generated from all of the redundancy words. The respective lengths of the sub-strings and redundancy words may be determined by the CpC code implementation. The sub-strings may have equal lengths or different lengths. Similarly, the redundancy words may have similar lengths or different lengths.

Optionally, when an error is flagged, a data word is output. The output data word may be selected in accordance with logical rules (denoted herein error combatance logic). Examples of a data word which may be output in response to the flagged error include but are not limited to:

a) The data string at the input of the checker;

b) A function of the data string at the input of the checker;

c) A random or arbitrary data word; and

d) A pre-chosen string.

Outputting an arbitrary or random word may confuse an attacker who is expecting a correlation between the output word and the nature of the attack.

Optionally, the flag acts as a trigger for other actions such as:

a) Turning off the device;

b) Erasing a memory;

c) Replace data in a memory (e.g. with random or pre-specified data of no significance to an attacker);

d) Restart the device;

e) Delay device operation;

f) Activate an alarm;

g) Send a message to another device; and

h) Initiate processes for destruction of the device.

There are many other types of actions which may be triggered and the scope of the term “trigger other actions” is intended to encompass all such actions.

Optionally, the hardware device is one of:

a) A memory;

b) A logic circuit;

c) An integrated circuit (IC);

d) A programmable logic element; and

e) A communication device.

Optionally, the hardware device incorporates more than one of the devices listed above (e.g. a communication device which includes memories, programmable logic elements, etc.).

Optionally, the method is implemented by logic gates which operate on the data string to perform at least one of: generating the redundancy words, detecting errors and flagging detected errors.

Optionally, some aspects of the method for detecting errors in a data string are implemented by software and/or by firmware.

Optionally, the hardware device includes at least one non-transitory computer readable storage medium storing instructions and at least one processor configured to execute the instructions to generate the redundancy words and to flag detected errors.

The data string may be input by any means known in the art, in parallel and/or serially.

Optionally, the data string is read from a memory.

Optionally, the data string is read from a register.

Optionally, the data string is extracted from a data signal (e.g. a data signal received by a communication device).

Optionally, the data string is received through a data interface.

Optionally, the data string is read from a data bus in a logic circuit.

Optionally, the data string is obtained from nodes in a logic circuit (e.g. is conveyed by wires from the logic circuit nodes).

### 2. Checker

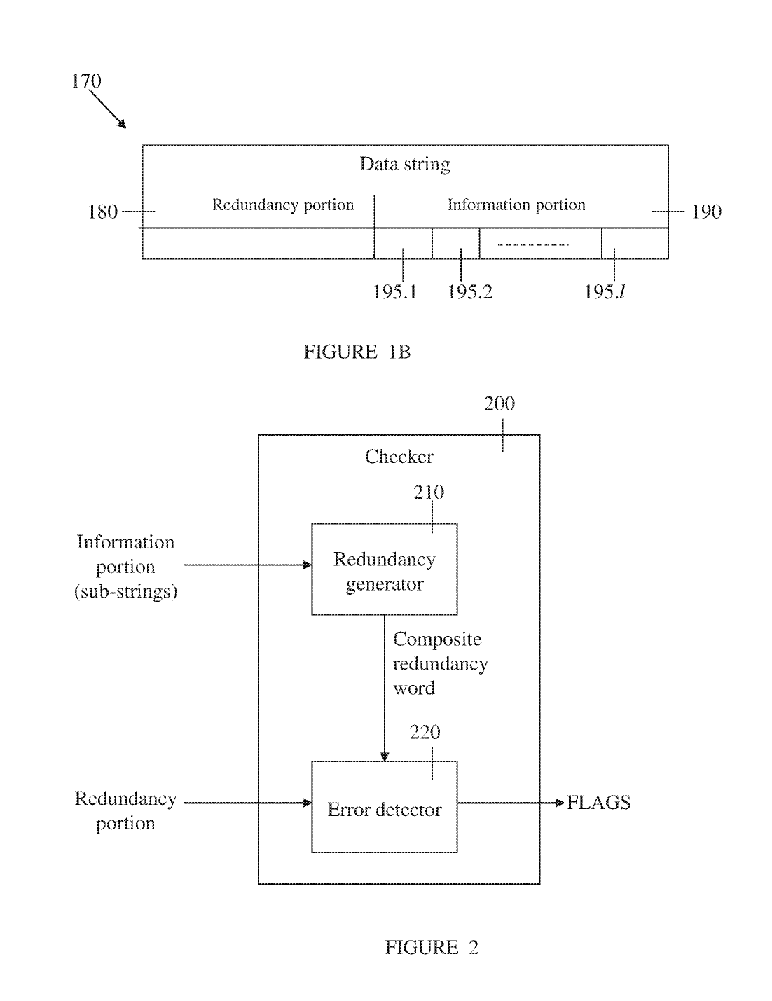

Reference is now made to FIG. 2, which is a simplified block diagram of a checker for detecting errors in a data string, according to embodiments of the invention.

Checker 200 includes redundancy generator 210 and error detector 220.

Redundancy generator 210 generates respective redundancy words for the sub-strings which together form the information portion of an input data string. Each sub-string's redundancy word is generated by encoding the sub-string with a respective separable robust code.

Redundancy generator 210 also generates the composite redundancy word from the sub-strings' respective redundancy words.

Optionally redundancy generator 210 generates the composite redundancy word by addition over a finite field of the respective redundancy words. Further optionally, the addition over a finite field is implemented using XOR and/or XNOR gates.

Checker 200 may operate serially, in parallel or with mixed parallel/serial operation. For example, a finite field multiplier which is used in the implementation of one or more sub-codes may have serial, parallel and mixed parallel/serial implementations.

Error detector 220 flags an error when the redundancy portion of the data string differs from the composite redundancy word.

When the goal of checker 200 is to detect fault injection attacks, the input data string is typically obtained as directly as possible from the hardware element or location which is susceptible to attack. For example, if the device susceptible to attack is a memory the data string checked by checker 200 may be read directly from the memory.

Optionally, further processing of the data is performed prior to and/or in parallel with the error detection. For example, if the CpC has error correcting capabilities, the correctable errors may be corrected first and then the possibly corrected data string is input to checker 200.

Optionally, checker 200 performs one or more other functions including but not limited to:

i) Error analysis;

ii) Error correction; and

iii) Triggering actions in response to the detected error (e.g. restoring uncorrupted data to a memory device, notifying another device or a user, etc.).

The codes used to generate the sub-string redundancy words may be the same code, may all be different codes or may differ partially (i.e. some sub-strings are encoded with the same code while others are encoded with different a code or codes). Furthermore, the redundancy words may have the same or different lengths.

Optionally the checker is integrated into a hardware device. Further optionally, the hardware device includes one or more of: a memory, a logic circuit, an IC, a programmable logic element or a communication device.

Optionally, checker 200 inputs the data string in at least one of the following ways:

a) Reading the data string from a memory;

b) Extracting the data string from a data signal;

c) Receiving the data string through a data interface;

d) Obtaining the data string from nodes in a logic circuit;

e) Reading the data string from a data bus in a logic circuit; and

f) Reading the data string from a memory.

### 3. Method of Encoding an Information String

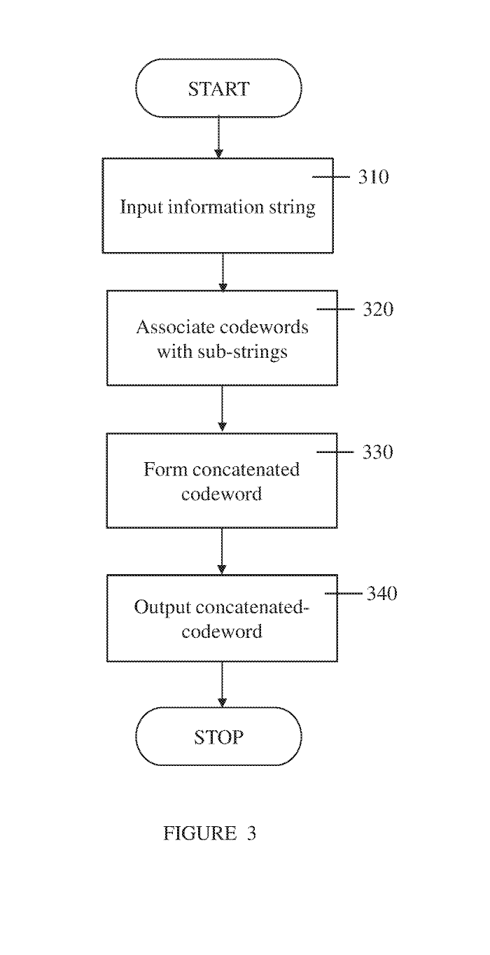

Reference is now made to FIG. 3, which is a simplified flowchart of a method of encoding information strings, according to embodiments of the invention. Optionally, the method is performed in a hardware device, as described in more detail below.

In 310 an information string formed of two or more sub-strings is input.

Optionally, the method of encoding includes the step (not shown) of separating the information string into sub-strings.

In 320 each sub-string is associated with a codeword of a respective separable robust code. Each of the associated codewords includes a respective information word and a respective redundancy word. Optional embodiments of associating a sub-string with a codeword include but are not limited to:

i) Performing a mathematical operation on the sub-string;

ii) Retrieving the codeword from a table; and

iii) Performing a mapping function to select a codeword.

In 330 a concatenated-codeword is formed. The concatenated codeword includes an information portion formed by concatenating the respective information words and a redundancy portion generated from the respective redundancy words.

Optionally, the redundancy portion is generated by addition over a finite field of the respective redundancy words within the codewords. Further optionally, the addition over a finite field is implemented using XOR and/or XNOR operations.

In 340 the concatenated-codeword is output.

The redundancy portion may be located in any location in the concatenated codeword which enables it to be extracted from the codeword without affecting the information portion. For example, the redundancy portion may precede the information portion, follow the information portion or be embedded in a known location (or locations) in the information portion.

Similarly to the error detection method (described in relation to FIG. 1A) the respective separable robust codes may be the same code or different codes. Further optionally, at least one of the separable robust codes is not a QS code.

Optionally, at least two of the redundancy words have a different length. Alternately, all of the redundancy words have the same length.

Optionally, the hardware device includes one or more of:

a) A memory;

b) A logic circuit;

c) An integrated circuit (IC);

d) A programmable logic element; and

e) A communication device.

Optionally, the method is implemented by logic gates which operate on the data string in order to perform at least one of: inputting the information string, associating the substrings with the codewords, forming the concatenated-codeword and outputting the concatenated-codeword.

Optionally, some aspects of the method of encoding information strings are implemented by software and/or by firmware.

Optionally, the hardware device includes at least one non-transitory computer readable storage medium storing instructions and at least one processor configured to execute the instructions to: input the information string and/or associate the substrings with the codewords and/or form the concatenated-codeword and/or output the concatenated-codeword.

The information string may be input and output by any means known in the art, in parallel and/or serially.

Optionally the information string is input by at least one of;

i) Reading the information string from a memory;

ii) Extracting the information string from a data signal;

iii) Receiving the information string through a data interface;

iv) Obtaining the data string from nodes in a logic circuit;

v) Reading the information string from a data bus in a logic circuit; and

vi) Reading the data string from a memory.

### 4. Encoder

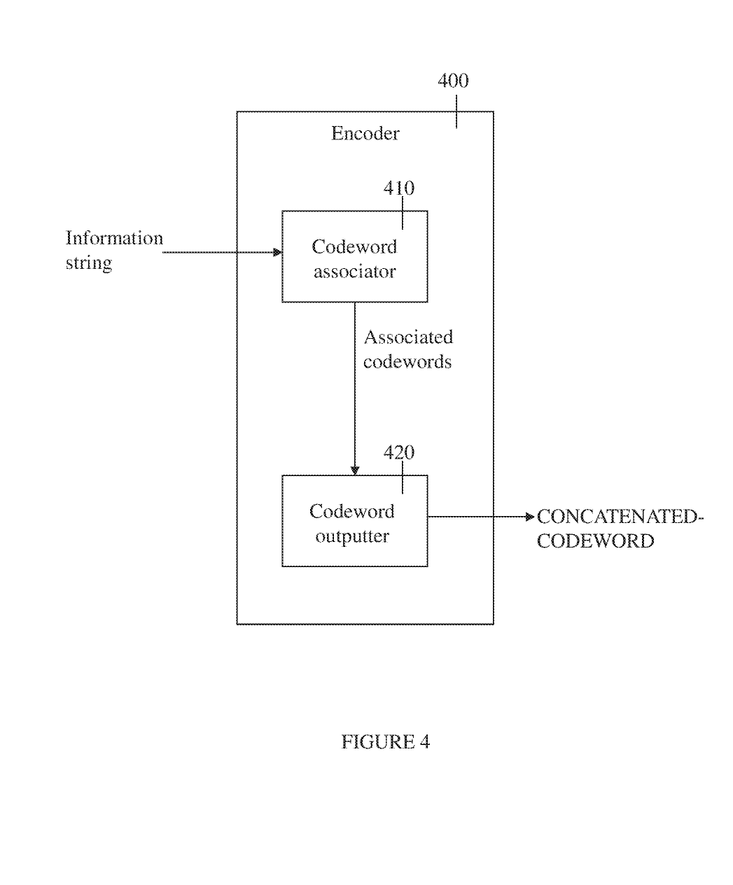

Reference is now made to FIG. 4 which is a simplified block diagram of an encoder according embodiments of the invention. Encoder 400 includes codeword associator 410 and codeword outputter 420.

Codeword associator 410 separates an information string into at least two sub-strings. Optionally, the sub-strings are input separately. Alternately or additionally, two or more of the sub-strings combined (e.g. concatenated) into single string which is sub-divided by codeword associator 410. The information string may be input by any means known in the art, in parallel and/or serially, similarly to the described above.

Codeword associator 410 associates each of the sub-strings with a codeword of a respective separable robust code. Each of the associated codewords includes a respective information word and a respective redundancy word. Codeword associator 410 generates a redundancy portion (for the concatenated codeword) from the respective redundancy words, optionally by addition over a finite field of the redundancy words. Further optionally, the addition over a finite field is implemented using XOR and/or XNOR gates.

Codeword outputter 420 outputs a concatenated-codeword. The concatenated codeword includes an information portion, formed as a concatenation of the respective information words, and the redundancy portion generated by codeword associator 410.

The separable robust codes used by codeword associator 410 may be the same code, may all be different codes or may differ partially (i.e. some sub-strings are encoded with the same code while others are encoded with a different code or codes).

The redundancy words may have the same or different lengths.

Encoder 400 may operate serially, in parallel or with mixed parallel/serial operation.

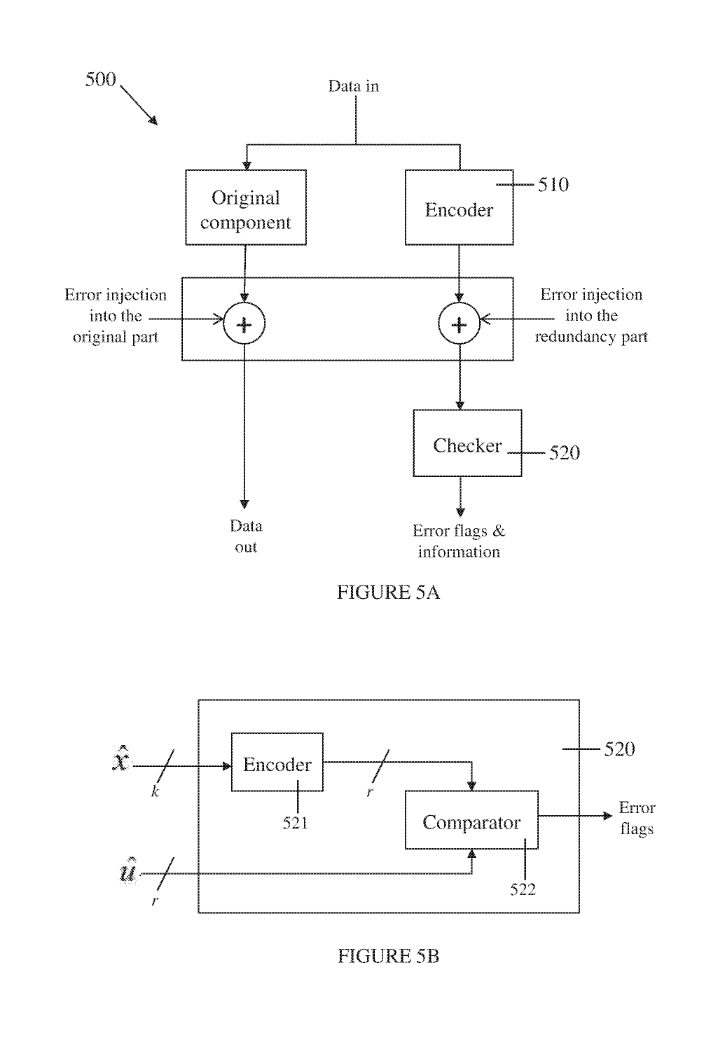

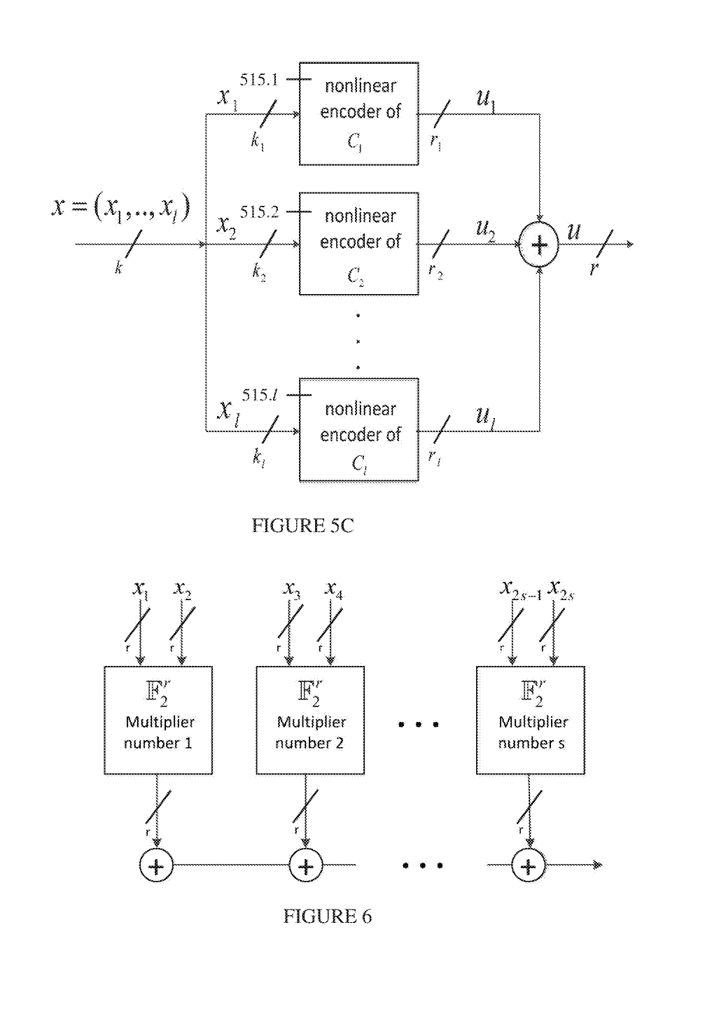

It will be appreciated that checker 200 and encoder 400 may include similar functionalities. It is noted that for a hardware system protected by a CpC code (as illustrated in FIG. 5A) the encoder functionality in the checker may or may not be implemented in the same way that it is implemented in the encoder.

Optionally encoder 400 is integrated into a hardware device. Further optionally, the hardware device is and/or includes: a memory, a logic circuit, an IC, a logic element or a communication device.

The information string may be input and output by encoder 400 by any means known in the art, in parallel and/or serially.

Optionally the information string is input by at least one of;

i) Reading the information string from a memory;

ii) Extracting the information string from a data signal;

iii) Receiving the information string through a data interface;

iv) Obtaining the information string from nodes in a logic circuit;

v) Reading the information string from a data bus in a logic circuit; and

vi) Reading the data string from a register.

### 5. Exemplary Embodiment of a Hardware System Protected by a CpC Code

Reference is now made to FIG. 5A, which is a simplified block diagram of a hardware system which is protected by a CpC code, according to exemplary embodiments of the invention.

Hardware system 500 includes encoder 510 and checker 520. Encoder 510 receives a k-bits information word termed x and outputs an r-bits redundancy word termed u. The information portion and the redundant portion form a codeword c=(x,u).

The codeword may be distorted by an adversary (shown in FIG. 5A as error injection into the original component and into the output of the encoder 510). Thus the (distorted) input to the checker is c+e=(\hat{x},û). Checker 520 checks whether the input word is a legal codeword.

Reference is now made to FIG. 5B, which is a simplified block diagram of a checker, according to exemplary embodiments of the invention. Checker 520 includes encoder 521 (which is optionally a copy of encoder 510) and comparator 522. Encoder 521 computes and outputs (\hat{x}), or, alternately, an entire codeword from which u(\hat{x}) is then extracted. Comparator 522 corresponds substantially to the above-described error detector (e.g. 220 in FIG. 2). Comparator 522 computes u(\hat{x}) and compares it to û. If u(\hat{x})≠û, comparator 522 outputs error flags indicating that an error has occurred and, optionally, additional information pertaining to the error.

Reference is now made to FIG. 5C, which is a simplified block diagram of an encoder, according to exemplary embodiments of the invention. CpC encoder 510 of the CpC code consists of 1 sub-encoders 515.1-515.1. The information word is divided into 1 vectors, i.e. x=(x₁, . . . , xₗ). Each xᵢ is the input of the respective sub-encoder of code Cᵢ. The output of CpC encoder 510 is computed from the outputs of the l sub-encoders by XORing their values.

### 6. Types of Circuits

Embodiments of CpC-based checkers and/or encoders may be implemented in circuits, including, but not limited to:

a) An integrated circuit (IC) customized for a particular use, such as an Application-Specific Integrated Circuit (ASIC);

b) A programmable logic device intended for general-purpose use. Examples of such programmable logic devices include, but are not limited to: Field-Programmable Gate Array (FPGA), Gate Array, Uncommitted Logic Array (ULA), Programmable Logic Array (PLA), Programmable Array Logic (PAL), Complex Programmable Logic Device (CPLD), Erasable Programmable Logic Device (EPLD) and Structured ASIC.

### 7. Analysis of CpC Codes

### Notations

Regular lowercase letters are used to represent scalars. Boldface lowercase letters are used to denote row vectors; e.g., x=(x₁, . . . , xₙ) is a vector of length n, 0ₙ denotes an all-zero vector of length n. Double stroke capital letters are used to denote an algebraic structure; e.g., [symbol] _{q} is a finite field with q elements. The field [symbol] ₂^{m} is identified herein with [symbol] ₂_{^{m}}. Calligraphic capital letters are used to denote codebooks; e.g., C, where |C| is the number of codewords in C. The operators ⊕ and ⊖ denote addition and subtraction in a finite field, respectively.

The effectiveness of security oriented codes with a deterministic encoder is measured in terms of their maximal error masking probability. The maximal error masking probability of a code C is denoted by Q̅=max_{e≠0}Q(e) where Q(e) is the probability that an error e is masked by a codeword of C. For uniformly distributed codewords, the error masking probability equals Q(e)=R(e)/|C| where the autocorrelation function:

R(e)=|{c|c,c⊕eϵC}| (1)

enumerates the number of codewords that mask the error e. A code C is called robust if Q(e)<1 for any nonzero error e [6].

The maximal error masking probability of a systematic binary code is lower bounded by [3]:

Q̅≥max{2^{-k+1},2^{-r}}, (2)

and for non binary codes by:

Q̅≥max{q^{-k},q^{-r}}. (3)

A code that satisfies equality in the lower bound on Q is called optimum.

A distinction is made herein between perfect, optimum and optimal codes. Perfect robust codes satisfy equality in the bound

$$\overline{Q} \geq \frac{{q}^{k} - 1}{{q}^{n} - 1} ;$$

however, systematic codes cannot be perfect. Systematic codes follow the bounds in Eqns. 2 and 3. Codes that satisfy equality in this bound are called optimum. In some cases, this bound is not achievable; codes that minimize Q̅ but do not satisfy equality in bounds 2, 3 are termed optimal. This is, for example, the case if q=2, k=3 and r=1; in this case, no code satisfies Q̅=0.5, and the TS code that has Q̅=0.75 is optimal. On the other hand, if q is an odd prime, the bound is always achievable, for instance, by the PS code.

The Quadratic-Sum (QS) code is an optimum robust code for the case where k=2sr and q is a prime. The Punctured Square (PS) code is also an optimum robust code for any r≤k where q is an odd prime. The Punctured Cubic (PC) code is an optimum code for some values of r and close to optimum for others.

Punctured codes (e.g. PS/PC codes) may be constructed for arbitrary values of k and r; however, their hardware implementation cost is relatively high, as it requires a (punctured) multiplication and squaring in the finite field [symbol] _{q}_{^{k}} [12]. In contrast to the punctured codes, the QS code is considered to have a low hardware implementation cost since its implementation requires s identical finite field multipliers and adders over the smaller field [symbol] _{q}_{^{r}} [13]. However, the dimension of a QS code must be an even multiple of r.

In addition to these two codes, other codes such as the Shortened QS (sQS), the Triple QS (tQS) and the Triple Sum (TS) exist. These codes are variants of the QS code [14]. The sQS code may be constructed for an arbitrary rate; however, its error masking probability is relatively high and in some cases, it is not robust. The tQS code is a non-binary optimum robust code for k=(2s+1)r, and the TS is a binary close to optimum robust code for k=(2s+1)r.

### 8. Code-Plus-Codes (CpC) Coding Scheme

The Code plus Codes (CpC) coding scheme described herein is a high-rate low-complexity robust code built upon a set of systematic robust codes {Cᵢ}_{1≤i≤l} of dimension kᵢ, and having rᵢ redundant symbols. Optionally, the kᵢ's are chosen to minimize the hardware complexity.

For clarity, in this non-limiting analysis systematic code C(n,k) is associated with a systematic code C′(n′, k) whose codewords are derived from C by appending n′−n zeros to each codeword; i.e.,

C′={(x,u′)u′=(u,0_{n′-n}),n′>n and (x,u)ϵC}.

Denote by R′(e), Q′(e) and Q̅′̅, the autocorrelation function, the error masking probability and the maximal error masking probability of the code C′, respectively.

### Construction 1 Let:

Cᵢ(nᵢ,kᵢ)_{q}={(x,u):xϵ [symbol] _{q}^{k}^{ᵢ},uϵ [symbol] _{q}^{r}^{ᵢ}}, i=1 . . . l

be a set of l robust codes, each with kᵢ information symbols and rᵢ redundancy symbols and length nᵢ=kᵢ+r₁. The maximal error masking probability of Cᵢ is denoted by Q̅ᵢ.

Define r=max_{1≤i≤l}rᵢ and k=Σᵢ₌₁^{l}kᵢ. Denote by C′ᵢ(kᵢ+r,kᵢ) the corresponding zero-padded codes. The CpC code C(n=k+r,k)_{q} consists of the codewords:

$$C = \{ \begin{matrix}( x , u ) \text{:} & x = ( {x}_{1} , … , {x}_{l} ) ∈ {𝔽}_{q}^{k} , \\ & u = {{⊕}^{l}}_{i = 1} {u}_{i}^{′} ( {x}_{i} ) ∈ {𝔽}_{q}^{r} , \\ & ( {x}_{i} , {u}_{i}^{′} ) ∈ {C}_{i}^{′}\end{matrix} \} .$$

Theorem 1 The CpC code C is a robust code with:

$$\overline{Q} = {max}_{1 \leq i \leq l} ( {\overline{Q}}_{i} ) .$$

### Proof.

Let c=(x₁, . . . , xₗ, u)ϵC be a codeword and let e=(eₓ, eᵤ) be a nonzero error vector, where eₓ=(eₓ_{₁}, . . . , eₓ_{ₗ}) and eₓ_{ᵢ}ϵ [symbol] _{q}^{k}^{ᵢ}, eᵤ ϵ [symbol] _{q}^{r}.

First, note that Q̅′̅ᵢ̅=Q̅ᵢ̅. The correctness of this statement follows from Eq. 1; define e′ᵢ=(eᵢ, e₀) where eᵢ=(eₓ_{ᵢ}, eᵤ) and e₀ϵ [symbol] _{q}^{r-r}^{ᵢ}, then,

$${R}_{i}^{′} ( {e}_{i}^{′} ) = \{ \begin{matrix}{R}_{i} ( {e}_{i} ) & if {e}_{0} = {0}_{r - {r}_{{i}^{′}}} \\ 0 & otherwise\end{matrix} . \qquad ( 4 )$$

The error masking equation of the CpC code is:

$${{⊕}^{l}}_{i = 1} {u}^{′} ( {x}_{i} ⊕ {e}_{{x}_{i}} ) = {{⊕}^{l}}_{i = 1} {u}^{′} ( {x}_{i} ) ⊕ {e}_{u} . \qquad ( 5 )$$

If eₓ=0ₖ and eᵤ=0ᵣ, no error occurred, and hence R(e)=q^{k} and Q(e)=1.
If eₓ=0ₖ and eᵤ≠0ᵣ, then Q(e)=0.
For eₓ≠0ₖ, define eⱼ=(eₓ_{ⱼ}, v) and

$$t = {argmax}_{1 \leq j \leq l} {max}_{{e}_{j} , v ∈ {𝔽}_{q}^{r}} {Q}_{j}^{′} ( {e}_{j} ) .$$

For any fixed value of {xᵢ}_{i≠t} the error masking equation of C′ₜ becomes

$${u}^{′} ( {x}_{t} ⊕ {e}_{{x}_{t}} ) = {u}^{′} ( {x}_{t} ) ⊕ \underbrace{{e}_{u} {⊕}_{i \neq t} ( {u}^{′} ( {x}_{i} ) ⊖ {u}^{′} ( {x}_{i} ⊕ {e}_{{x}_{i}} ) )}_{v} .$$

Define eₜ=(eₓ_{ₜ},v). The number of solutions to this equation is e^{k}^{ₜ}(eₜ)=q^{k}^{ₜ}Qₜ(eₜ). Therefore, at most

$${\prod }_{i \neq t}^{ } {q}^{{k}_{i}} \cdot ( {q}^{{k}_{t}} { max}_{v} {Q}_{t} ( {e}_{t} ) ) \leq {q}^{k} {\overline{Q}}_{t}$$

x vectors solve the error masking equation of the CpC code. Consequently, the error masking probability of the CpC code is upper bounded by:

$$\overline{Q} = {max}_{1 \leq i \leq l} ( \overline{Q} i ) .$$

Corollary 1 the CpC Code is Optimum if all the l Ground Codes {Cᵢ}_{1≤i≤l} are Optimum Codes.

Using the CpC coding scheme, several codes may be combined to produce a low complexity robust code for any (k,r) pair. The ground codes may be the QS, PC, PS, sQS, tQS, TS codes or possibly other robust codes.

### Example 1

Consider the case where q=3, k=23 and the desired maximal error masking probability is Q̅≤3⁻⁶. Table 1 shows several different constructions for this set of parameters. The first three columns correspond to Q̅, r and the code structure, respectively. The fourth column shows the (largest) finite field in which the encoding is performed. Note that since k cannot be expressed as (2s+1)r it is not possible to construct a tQS code.

TABLE 1
Constructions ternary C(23 + r, 23) codes

| Q̅ | r | Code | Comp. |
|---|---|---|---|
| 3⁻⁵ | 7 ≤ r ≤ 11 | sQS(23 + r, 23) | [symbol] ₃^{r} |
| 3⁻⁶ | 6 | PS(23 + 6, 23) | [symbol] ₃²³ |
| 3⁻⁶ | 6 | ${CpC}_{1} = PS ( 12 + 6 , 12 ) + PS ( 11 + 6 , 11 )$ | [symbol] ₃¹² |
| 3⁻⁶ | 6 | ${CpC}_{2} = QS ( 12 + 6 , 12 ) + PS ( 11 + 6 , 11 )$ | [symbol] ₃¹¹ |
| 3⁻⁶ | 6 | ${CpC}_{3} = PS ( 8 + 6 , 8 ) + PS ( 8 + 6 , 8 ) + PS ( 7 + 6 , 7 )$ | [symbol] ₃⁸ |
| 3⁻¹¹ | 12 | sQS(23 +12, 23) | [symbol] ₃¹² |

### Example 2

Consider the case where q=2, k=32 and the desired maximal error masking probability is Q̅≤2⁻⁹. Some of the possible constructions for this set of parameters are shown in Table 2. The fifth column of Table 2 shows the implementation cost in terms of the number of two-input logic gates. Note that since k cannot be expressed as (2s+1)r it is not possible to construct a TS code. The sQS has the smallest cost; however, its error masking probability is higher than required. Therefore, the best code is the CpC₃ code. The technique used to compute the implementation cost is described below.

TABLE 2
Constructions of binary C(32 + r, 32) codes

| Q̅ | r | Code | Comp. | W(C) |
|---|---|---|---|---|
| 2⁻⁸ | 10 | sQS(32 + 10, 32) | [symbol] ₂¹⁰ | 256 |
| 2⁻⁹ | 10 | PC(32 +10, 32) | [symbol] ₂³² | 1287 |
| 2⁻⁹ | 10 | ${CpC}_{1} = PC ( 16 + 10 , 16 ) + PC ( 16 + 10 , 16 )$ | [symbol] ₂¹⁶ | 814 |
| 2⁻⁹ | 10 | ${CpC}_{2} = PC ( 10 + 10 , 10 ) + PC ( 11 + 10 , 11 ) + PC ( 11 + 10 , 11 )$ | [symbol] ₂¹¹ | 675 |
| 2⁻⁹ | 10 | ${CpC}_{3} = QS ( 20 + 10 , 20 ) + PC ( 12 + 10 , 12 )$ | [symbol] ₂¹² | 483 |
| 2⁻¹⁶ | 16 | QS(32 +16, 32) | [symbol] ₂¹⁶ | 553 |

### 9) Implementation Costs

Optionally, the implementation costs of a particular CpC code are calculated based on the property that any code is either a ground code or a CpC code, and a CpC code may be represented as a sum of two ground codes of smaller dimension, which themselves may be either a CpC code or ground code.

A description of the implementation cost of the QS, TS, PC and sQS codes in terms of the number of two-input AND and XOR gates is now presented. As described below, the respective implementation costs of these ground codes may be used to calculate the overall implementation cost of a particular CpC code constructed from these ground codes.

The following notations are used:

W(C) is the implementation cost of the code's encoder,

XOR and AND are respectively the implementation costs of two-input XOR and AND gates,

SQR(m) is the implementation cost of a module which computes x² over [symbol] ₂^{m},

MUL(m) is the implementation cost of a finite field multiplier over [symbol] ₂_{^{m}},

pMUL(m,mₒᵤₜ,Sₚ) is the implementation cost of a punctured multiplier; i.e., a multiplier over [symbol] ₂^{m} which generates only mₒᵤₜ output bits (out of the m bits), where the set of unused output bits is defined by Sₚ,

sMUL(m, z₁, z₂) is the implementation cost of a shortened finite field multiplier; i.e., a multiplier over [symbol] ₂^{m} whose first and second operands have respectively z₁ and z₂ zeros at predefined (fixed) coordinates.
Using the above notations, the cost of a CpC code, W(C), is given by:

W(C)=Σᵢ₌₁^{l}W(Cᵢ)+(Σᵢ₌₁^{l}rᵢ−r)XOR. (6)

### 9.1. The QS Code

The QS code is an optimal robust code for k=2sr. The QS code is defined as:

C_{QS}={(x,u):xϵ [symbol] ₂_{^{r}}^{2s},u=Σᵢ₌₀^{s-1}x₂ᵢ₊₁x₂ᵢ₊₂ϵ [symbol] ₂_{^{r}}}

where x=(x₁, x₂, . . . , x₂ₛ), xᵢ ϵ [symbol] ₂_{^{r}} for 1≤i≤2s. The implementation of the QS code consists of s multipliers over the field [symbol] ₂_{^{r}} and s−1 r-bit adders. A schematic illustration of an exemplary encoder of a QS code is depicted in FIG. 6. The implementation cost of a QS code is given by

W(QS(n,k))=s·MUL(r)+(s−1)·r·XOR.

### 9.2. The TS Code

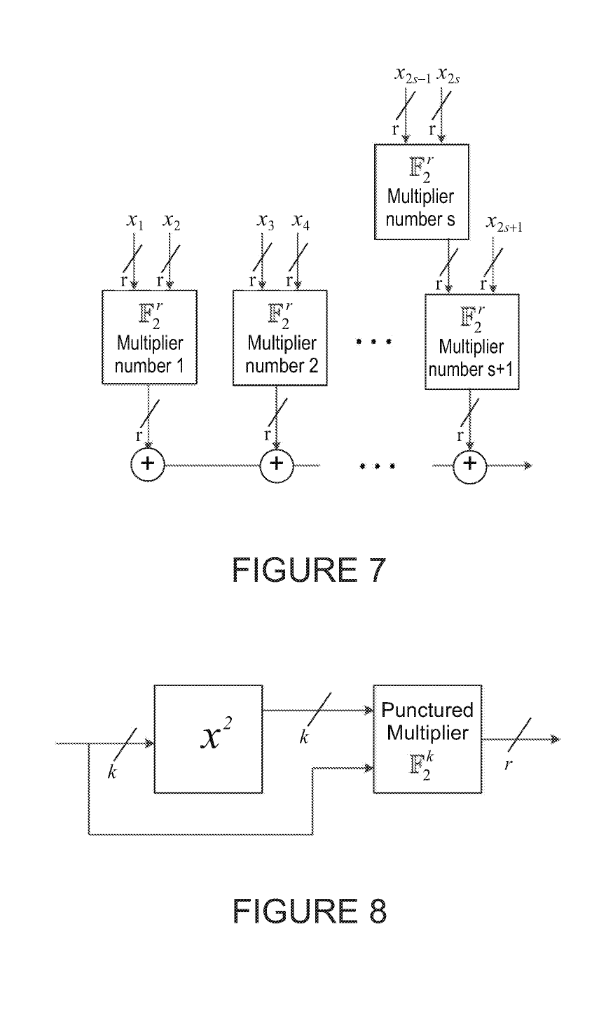

The TS code is a close to optimal robust code for k=(2s+1)r with Q̅_{TS}=2^{-r+1}−2^{-2r}. The TS code is defined as:

$${C}_{TS} = \{ ( x , u ) : u = {\sum }_{i = 0}^{s - 2} {\prod }_{j = 1}^{2} {x}_{( 2 i + j )} ⊕ {\prod }_{i = 2 s - 1}^{2 s + 1} {x}_{i} ∈ {𝔽}_{2} r \}$$

where, x=(x₁, . . . x₍₂ₛ₊₁₎), xᵢ ϵ [symbol] ₂_{^{r}} for 1≤i≤(2s+1). The implementation of the TS encoder consists of s+1 multipliers over the field [symbol] ₂_{^{r}} and s−1 r-bit adders. The encoder of the TS code is similar to the encoder of the QS code where the s'th multiplier is replaced by two multipliers, as depicted in FIG. 7.

The implementation cost of the TS code is given by:

W(TS(n,k))=(s+1)·MUL(r)+(s−1)·r·XOR.

### 9.3. The PC Code

The PC code is a close to optimal robust code with Q̅_{PC}=2^{-r+1}. The PC code is defined as

C={(x,u)|xϵ [symbol] _{q}^{k},u=x³Pϵ [symbol] _{q}^{r}}

where P is a binary k×r matrix of rank r≤k and the Hamming weight of each row in P is 1.

The implementation of the PC code consists of a punctured multiplier and a block that computes x² over [symbol] ₂_{^{k}}. A schematic illustration of the encoder of the PC code is depicted in FIG. 8.

The implementation cost of the PC code is given by:

W(PC(n,k))=SQR(k)+pMUL(k,r,Sₚ).

### 9.4. The sQS Code

The sQS is a modification of the QS code for cases when k=2sr−Δ, 0<Δ<2r. A sQS code is constructed by embedding Δ zeros into the information portion \tilde{x}ϵ [symbol] _{q}^{\tilde{k}} to form xϵ [symbol] _{q}^{2sr} and calculating the redundancy u(x) of a QS code. A codeword c=(\tilde{x},u(x))ϵsQS is a vector of length k+r.

Denote the number of embedded zeros in xᵢ by hᵢ and define h̅=max_{1≤i≤2s}hᵢ. The value of h̅ determines the maximal error masking probability [14]:

Q̅_{sQS}=2^{-r+h̅}.

Hence, the error masking probability is minimized when

$$\overline{h} = ⌈ \frac{Δ}{2 s} ⌉ ,$$

equivalently,

Δ=2s·h̅−(2τ+δₛ)

where τ<s and δₛ=Δ mod 2. In this case, hᵢ=h̅ for i≤2τ+δₛ, and equals h̅−1, otherwise. The implementation cost of the sQS code is as follows:

W(sQS(n,k))=(s−τ−δₛ)·sMUL(k,h̅,h̅))+δₛ·sMUL(k,h̅,h̅−1)+τ·sMUL(k,h̅−1,h̅−1)+(s·1)·r·XOR.

Note that if Δ<2s−1, the implementation employs both finite field multipliers and shortened finite field multipliers (i.e. sMUL(k,0,0)=MUL(k)).

### 10) Implementation of Finite Field Arithmetics

### 10.1. Finite Field Multipliers

A finite field multiplier over [symbol] ₂^{k} is a hardware component which receives two inputs a, bϵ [symbol] ₂_{^{k}} and outputs sϵ [symbol] ₂_{^{k}} where s=a·b mod π(x) and π(x) is an irreducible polynomial of degree k over [symbol] ₂. The implementation cost is minimal when a bit parallel multiplier is implemented and π(x) is a trinomial [18]. In cases where there is no such trinomial it is commonplace to use irreducible polynomials with special structures such as pentanomials [19].

Multiplication in a simple parallel multiplier is done in two steps [18]. The first step is the multiplication of two polynomials a=Σᵢ₌₀^{k-1}aᵢxⁱ, b=Σᵢ₌₀^{k-1}bᵢxⁱ. The result is a polynomial ŝ of degree ≤2 (k−1),

ŝ=Σⱼ₌₀^{2(k-1)}ŝⱼx^{j}

where

ŝⱼ=Σ₍ᵢ_{ₐ}_{,i}_{_{b}}_{)ϵŝ}_{ⱼ}aᵢ_{ₐ}bᵢ_{_{b}} (7)

and

Ŝⱼ={(iₐ,i_{b})|iₐ+i_{b}=j,0≤iₐ,i_{b}<k}. (8)

Note that the number of gates that are required to implement ŝⱼ, 0≤j<k is

$$W ( {\hat{s}}_{j} ) = \vert {\hat{S}}_{j} \vert AND + ( \vert {\hat{S}}_{j} \vert - 1 ) XOR = \{ \begin{matrix}( j + 1 ) AND + jXOR & 0 \leq j < k . \\ ( 2 k - 1 - j ) AND + ( 2 k - 2 - j ) XOR & k \leq j < 2 k - 1.\end{matrix} \qquad ( 9 )$$

The second step is a reduction modulo π(x),

Σᵢ₌₀^{k-1}sᵢxⁱ=Σⱼ₌₀^{2(k-1)}ŝⱼx^{j} mod π(x). (10)

Let dⱼ be the binary representation of x^{j+k} mod π(x) in [symbol] ₂^{k} and let Rⱼ be the support of dⱼ [12]. Let:

Mᵢ={|0≤j<k−1 and iϵRⱼ},

be the set that defines which Ŝⱼ's are used in the calculation of sᵢ. That is, for 0≤i<k, each output coordinate, s₁, is computed as the sum of:

sᵢ=ŝᵢ⊕Σ_{jϵM}_{ᵢ}ŝⱼ₊ₖ.

Using these notations, define W(sᵢ),

W(sᵢ)=W(ŝᵢ)+|Mᵢ|XOR

W(sᵢ) is the implementation cost of sᵢ excluding the number of two-input gates required to implement the coefficients ŝⱼ of the high powers of ŝ, k≤j≤2(k−1).

The total cost of a finite field multiplier is then

$$MUL ( k ) \leq {\sum }_{0 \leq i < k} W ( {s}_{i} ) + {\sum }_{k \leq j \leq 2 ( k - 1 )} W ( {\hat{s}}_{j + k} ) = {k}^{2} AND + {( k - 1 )}^{2} XOR + {\sum }_{0 \leq i < k} \vert {M}_{i} \vert XOR .$$

In some cases it is possible to reduce the implementation cost of step 2 [20]. This leads to:

MUL(k)≤k² AND+(k−1)(k+p−2)XOR (11)

where p is the number of nonzero terms in π(x) [18].

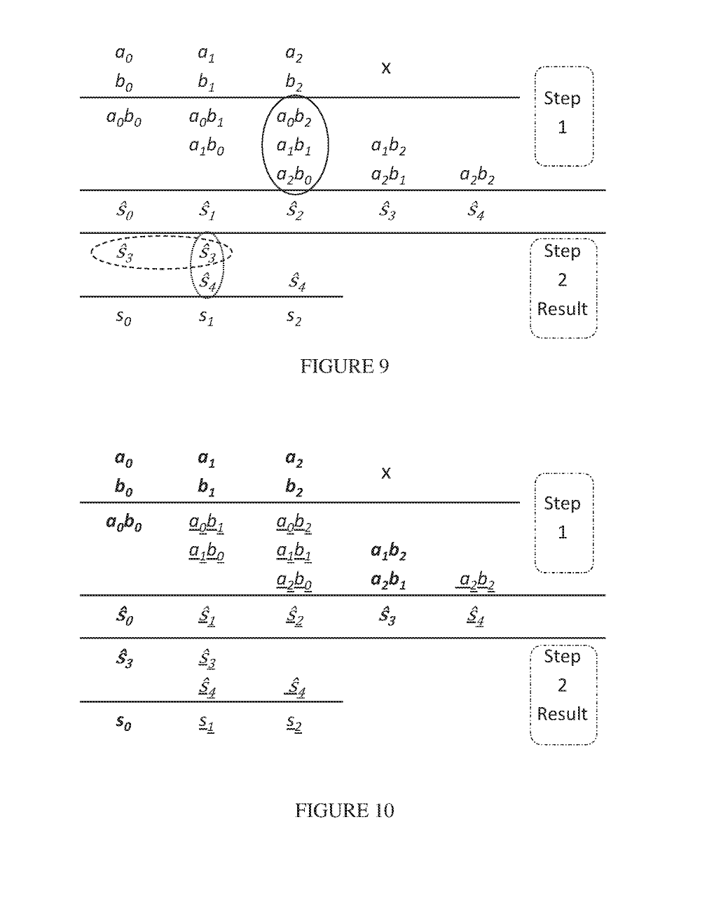

Reference is now made to FIG. 9, which is an example of a finite field multiplication in [symbol] ₂³ where π(x)=x³+x+1. Set Ŝ₂ is circled in a solid line, set R₀ is circled in a dashed line and set M₁ is circled in a dotted line.

In this example, s₂=(a₀b₂⊕a₁b₁⊕a₂b₀)⊕ŝ₄. Hence, W(s₂)=W(ŝ₂)+|M₂|=3AND+3XOR. Here, MUL(3)=9AND+8XOR.

### 10.2. Punctured Finite Field Multipliers

A punctured finite field multiplier is a multiplier that outputs a subset of the product bits. The set of coordinates (i.e., the sⱼ's) that are punctured is denoted as Sₚ. The hardware complexity of a punctured multiplier is

pMUL(k,r,Sₚ)=MUL(k)−Δ(Sₚ)

where Δ(Sₚ) is the number of gates removed from the design because of the puncturing.

The encoder of a PC code includes a punctured multiplier. The size of Sₚ in this multiplier equals k−r, and the elements in Sₚ are determined by the code's puncturing matrix P. Since the error masking probability of the PC code does not depend on the choice of P it may be chosen in a way that minimizes the implementation cost.

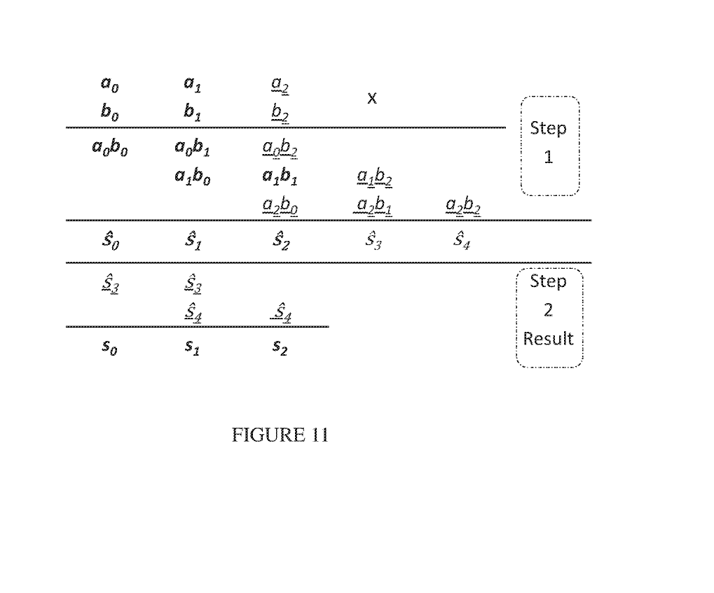

Reference is now made to FIG. 10, which is a simplified illustration of a punctured finite field multiplication in [symbol] ₂³ where π(x)=x³+x+1 with puncturing set Sₚ={1,2}. The gates from the original multiplier that are implemented appear in bold. The gates from the original multiplier that are not implemented are underlined. For Sₚ={1,2}, the implementation cost is pMUL(3,1,Sₚ)=3AND+2XOR.

The following multiplier is considered optimal since it has the smallest possible hardware complexity:

Δ(Sₚ)=(k−r)·rAND+(k−r)·rXOR.

No optimal constructions for optimal punctured multipliers over fields that cannot be defined by trinomials are currently known. A naive puncturing of the k·r most significant bits of the product, denoted by S_{P}^{MSB} decreases the hardware complexity by [12]:

Δ(S_{P}^{MSB})≥½(k+r)(k−r)AND+½(k+r)(k−r)XOR. (12)

The bound in Eq. 12 disregards the contribution of coefficients of the high powers, ŝⱼ, k≤j<2k−1, to Δ(Sₚ). To evaluate Δ(Sₚ), consider the set Rⱼ that was defined in Sec. 10.1. If Rⱼ⊆Sₚ then ŝⱼ₊ₖ is not implemented in the punctured multiplier.

For example, in the punctured multiplier in FIG. 10, R₀={0,1} and R₁={1,2}. Therefore if Sₚ={1,2} then R₁ ⊆Sₚ and ŝ₁₊₃ is not implemented.

Consider a set

\hat{R}ᵥ=∪_{jϵsupp(v)}Rⱼ,

for vϵ [symbol] ₂^{k-1}. For instance, in the punctured multiplier in FIG. 10, \hat{R}_{[01]}=R₀ and \hat{R}_{[11]}=R₀∪R₁.
Corollary 2 if \hat{R}ᵥ ⊆Sₚ then for all jϵsupp(v), ŝⱼ₊ₖ is not Implemented.

As a result,

$$Δ ( {S}_{P} ) = {\sum }_{i ∈ {S}_{P}} W ( {s}_{i} ) + {\sum }_{{0 \leq j < k - 1}_{{R}_{j} ⊆ {S}_{P}}} W ( {\hat{s}}_{j + k} ) = {\sum }_{i ∈ {S}_{P}} W ( {s}_{i} ) + {max}_{v ∈ {ℤ}_{2}^{k - 1} , {\hat{R}}_{v} ⊆ {S}_{P}} {\sum }_{j ∈ supp ( v )} W ( {\hat{s}}_{j + k} ) .$$

Let T={t₀ . . . tₖ₋₁} be an ordered set of indices that contains a permutation of [symbol] ₖ such that W(sₜ_{₀})≥W(sₜ_{₁}) . . . ≥W(sₜ_{_{k−1}}). In general, puncturing the set S_{P}^{Order}={t₀ . . . tₖ₋ᵣ₋₁} is a naive solution for the puncturing problem. It chooses the coordinates that maximize W(sᵢ) and disregards the possible contribution of ŝⱼ (k≤j<2k−1) to Δ(S_{P}). In many cases, S_{P}^{Order}=S_{P}^{MSB}.

Corollary 2 enables us to consider a non-naive solution; Algorithm 1, presented below, is a recursive greedy algorithm that receives a (k,r) pair and outputs an optimal puncturing set denoted by Sₚ*. The algorithm uses the predefined set

Uₖ₋ᵣ={\hat{R}ᵥ:|\hat{R}|=k−r}.

ALGORITHM 1
Algorithm GetBestPunc(k, r)

```
GetBestPunc(k, r):
If r = k then
  S_{P}^{*} = ϕ
else
  S_{P}^{Order} = {t₀ . . . tₖ₋ᵣ₋₁}
  S_{P}^{Rec} = GetBestPunc(k, r − 1)
  ${S}_{P}^{1} = {S}_{P}^{Rec} ⋃ arg {max}_{{0 \leq i < k}_{i ∉ {S}_{P}^{Rec}}} W ( {s}_{i} )$
  U_{S} = {S_{P}^{Order}, SP1} ∪ Uₖ₋ᵣ.
  Choose S_{P}^{*} ∈ U_{S} to be the set that minimizes pMUL(k, r, S_{P}).
end
```

The time complexity of Algorithm 1 is [symbol] (|Uₖ₋ᵣ|). It has smaller time complexity than a naive algorithm ( [symbol] (2^{k})), which computes Δ(S_{P}) for all the possible puncturing sets Sₚ. Note that for small fields (k≤16) defined by pentanomials, the puncturing sets produced by this algorithm are identical to those obtained by exhaustive search.

### 10.3. Shortened Finite Field Multipliers

A shortened finite field multiplier is used to implement the encoder of the sQS code. Since in each operand some of the input bits are shortened (i.e., set to be zeros), its implementation cost may be reduced by carefully choosing the coordinates of these bits.

Let Hₐ and H_{b}, respectively, be the set of shortened coordinates of the k-bit operands a and b, |Hₐ|=hₐ<k and |H_{b}|=h_{b}<k. In general,

sMUL(k,hₐ,h_{b})=MUL(k)−N_{AND}AND−N_{XOR}XOR,

where N_{AND} and N_{XOR} are the numbers of AND and XOR gates that are not implemented, respectively. Since the implementation of a finite field multiplier involves Eq. 7 (i.e. the first step of the computation), the computation of aᵢ·bⱼ for all 0≤i, j<k is part of a multiplier. Shortening hₐ bits of one operand and h_{b} bits of the second leaves us with N_{AND}=(k−hₐ)(k−h_{b}) products. Note that the position of the shortened bits, does not affect the value of N_{AND}.

Similarly, each input coordinate contributes to at least k−1 XOR gates in the implementation of Eq. 7; i.e., in step 1 of the computation. However, each coordinate in Hₐ, H_{b} has a different effect on the implementation cost of Eq. 10 (i.e., the second step of the multiplication). That is, N_{XOR}=N_{XOR,1}+N_{XOR,2} where:

N_{XOR,1}=(k−(hₐ−1))(k(h_{b}−1)).

Since the values of N_{AND} and N_{XOR,1} do not depend on the choice of Hₐ, H_{b}, the choice of Hₐ, H_{b}, depends solely on maximizing N_{XOR,2}, which is affected by π(x).

Let:

H_{a,b}={(iₐ,i_{b})|iₐϵHₐ or i_{b}ϵH_{b}}

be the set that corresponds to all the omitted AND gates. The size of H_{a,b} is N_{AND}, and is independent of the choice of Hₐ, H_{b}; however, its content varies and it has an impact on N_{XOR,2}. Let:

Jₛ={j|k≤j<2k−1 and Ŝⱼ⊆H_{a,b}},

that is, jϵJₛ, if ŝⱼ is not used in step 2 of the computation. In fact, sᵢ=ŝᵢ+Σ_{jϵM}_{ᵢ}_{\J}_{ₛ} ŝⱼ₊ₖ. The set Jₛ and π(x) define the size of N_{XOR,2}. Namely,
Theorem 2 The implementation cost of the sets Hₐ={i:k−1−hₐ<i≤k−1}, H_{b}={i:k−1−h_{b}<i≤k−1} is less than or equal to the implementation cost of any other pair of sets. In this case Jₛ={j|2k−hₐ−h_{b}≤j≤2k−2}.

Proof:

First note that at most hₐ+h_{b} pairs may be removed from Ŝⱼ. Thus, any Ŝⱼ greater than hₐ+h_{b} in size cannot be contained in H_{a,b}. Following Eq. 9,

Jₛ⊆{j:2k−2−hₐ−h_{b}≤j≤2k−2},

that is:

|Jₛ|≤hₐ+h_{b}. (13)

The minimal cost is achieved when the size of Jₛ is maximal and equality holds in the Eq. 13. Using the definition of Ŝⱼ, equality holds if for each element in {j|2k−2−hₐ−h_{b}≤j≤2k−2}, and for each (iₐ,i_{b})ϵŜⱼ, either iₐ ϵHₐ or i_{b} ϵH_{b}. Notice that Hₐ={i:k−1−hₐ<iₐ≤k−1}, H_{b}={i:k−1−h_{b}<i_{b}≤k−1} satisfies this restriction and provides the maximal Jₛ set.

Step 2 of the multiplication requires the addition of ŝⱼ₊ₖ to the coordinators in Rⱼ, if it is used in the shortened multiplier. If Hₐ and H_{b} are chosen according to Th. 2, then none of the ŝⱼ's for which 2k−2−hₐ−h_{b}≤j≤2k−2 are implemented. Hence, step 2 may be implemented using Σⱼ₌ₖ^{2k-2-h}^{ₐ}^{-h}^{_{b}}|Rⱼ₋ₖ| XOR gates. Therefore,

$$sMUL ( k , {h}_{a} , {h}_{b} ) \leq ( k - {h}_{a} ) ( k - {h}_{b} ) AND + {\underbrace{( k - {h}_{a} + 1 ) ( k - {h}_{b} + 1 )}}_{to compute the {\hat{s}}_{j} ′s} XOR + \underbrace{{\sum }_{j = k}^{2 k - 2 - {h}_{a} - {h}_{b}} \vert {R}_{j - k} \vert}_{to compute the {s}_{j} ′s} XOR . \qquad ( 14 )$$

Denote by p the number of terms in π(x). The bound from Eq. 14 may be further improved by implementing a shortened multiplier such that:

$$sMUL ( k , {h}_{a} , {h}_{b} ) \leq ( k - {h}_{a} ) ( k - {h}_{b} ) AND + {\underbrace{( ( k - {h}_{a} + 1 ) ( k - {h}_{b} + 1 )}}_{to compute the {\hat{s}}_{j} ′s} XOR + {\underbrace{( k - {h}_{a} - {h}_{b} - 1 ) ( p - 1 )}}_{to compute the {s}_{j} ′s} XOR .$$

Reference is now made to FIG. 11, which is a simplified illustration of a shortened multiplier in [symbol] ₂³ with hₐ=h_{b}=1. The gates that are implemented appear in bold. The gates that are not implemented appear are underlined. In this case, Hₐ=H_{b}={2}; i.e., a₂ and b₂ are constant zeros. As a result, s₃ and ŝ₄ are also constant zeros. The implementation cost is sMUL(3,1,1)=4AND+XOR.

### 10.4. Computation of 2nd Powers (Squarer)

This hardware component implements a² mod π(x)=(aₖ₋₁x^{2(k-1)}+aₖ₋₂x^{2(k-2)}+ . . . a₁x²+a₀) where aϵ [symbol] ₂_{^{k}} [19]. Therefore its implementation consists of only some of the XOR gates from the second step of the corresponding finite field multiplier. For a trinomial π(x)=x^{k}+x^{e}+1 the implementation cost is SQR(k)≤(k+e−1)/2. Note that tighter bounds may be achieved for certain classes of trinomials [21, 18, 22].

### 11. Minimizing the Hardware Complexity of the CpC Code

### 11.1. The Minimization Problem

In the optional embodiments presented below, the goal is to find a code that minimizes the hardware complexity for a given number of information bits k and whose maximal error masking probability is at most Qₛ.

Denote by S_{C}^{<k,Q}^{ₛ}> a family of systematic robust codes of dimension k and r≤log(Qₛ)+1 redundant symbols whose error masking probability is lower than Qₛ. A code in this family is denoted by C^{<k,Q}^{ₛ}^{>}. As denoted herein, the set S_{C}^{<k,Q}^{ₛ}^{>} consists of all the ground codes that were presented (QS, PC, TS and sQS) and the CpC codes built upon them. Denote by C^{<k,Q}^{ₛ}^{>}=arg min_{CϵS}_{_{C}}_{^{<}}_{k,Qs>} W(C) the code that minimizes the implementation cost.

Alternately or additionally, other minimization criteria are used, such as minimizing the hardware complexity for a given k and r. As will be appreciated, minimizing the hardware complexity using different minimization criteria may be performed in an analogous manner.

### Example 3

Consider the binary codes from Example 2, with k=32 and the desired maximal error masking probability Qₛ=2⁻⁹. Table 3 shows the implementation cost of each construction computed using the cost functions presented above.

TABLE 3
Implementation cost of C(32 + r, 32) codes

| code | XOR | AND | W(C) | Q̅ |
|---|---|---|---|---|
| QS(32 + 16, 32) | 297 | 256 | 553 | 2⁻¹⁶ |
| PC(32 + 10, 32) | 725 | 562 | 1287 | 2⁻⁹ |
| CpC₁(32 + 10, 32) | 458 | 356 | 814 | 2⁻⁹ |
| CpC₂(32 + 10, 32) | 335 | 320 | 675 | 2⁻⁹ |
| CpC₃(32 + 10, 32) | 262 | 221 | 483 | 2⁻⁹ |
| sQS(32 + 10, 32) | 88 | 168 | 256 | 2⁻⁸ |

There are many ways to construct a CpC code for a given set of parameters. The implementation cost of each code depends upon factors including:

a. The Size of [symbol] ₂_{^{k}}

In general, the larger the k, the higher the implementation cost.

For example, MUL(6)=71, therefore, a QS(60+6,60) code has W(QS(60+6,60))=5·MUL(6)+4·6=379 gates, whereas a PC code with the same parameters requires SQR(60)+pMUL(60,6,Sₚ*={i|6≤i≤59})=749 gates, since pMUL(60,6,Sₚ*={i|6≤i≤59})=719. However, as was demonstrated in Ex. 2, a smaller computation field does not necessary yield a smaller hardware overhead.

b. The Weight of π(x)

Trinomial-based multipliers have lower hardware complexity than non-trinomial based multipliers of the same degree k (and sometimes of higher degrees as well). Trinomial based punctured multipliers (with an optimal puncturing set Sₚ*) have the lowest hardware complexity with respect to other punctured multipliers of the same k and r.

For example, there is no irreducible trinomial for k=16. If one uses the pentanomial π(x)=x¹⁶+x¹²+x³+x+1, then for r=5 the best puncturing set is Sₚ*={iϵ [symbol] ₁₆ and i≠0,7,9,10,11}, and pMUL(16,5,Sₚ*)=232; whereas for k=17 and the trinomial π(x)=x¹⁷+x³+1 we have Sₚ*={iϵ [symbol] ₁₇ and i≠2,5,8,11,14} and pMUL(17,5,Sₚ*)=169. Consequently, W(PC(16+5,16)+sQS(9+5,9))=302 whereas W(PC(17+5,17)+sQS(8+5,8))=211.

c. Use of Optimum Codes

The QS is an optimum code; it needs only r−1 output bits to provide the error masking probability that a PC code can generate with r bits. This makes it possible to reduce the hardware complexity without increasing the maximal error masking probability.

For example, W(QS(42+7,42)+PC(11+8,11))=493 whereas W(sQS(42+8,42)+PC(11+8,11))=523 and the error masking probability of both codes is Q̅=2⁻⁷.

d. The Number of Instances of the Same Code

In some cases, a CpC scheme with multiple instances of the same ground code provides a smaller implementation cost.

For example, W(PC(50+18,50))=2558 whereas W(PC(25+18,25)+PC(25+18,25))=1840 which minimizes the hardware complexity.

Another example is the case where k=16 and r=3. The sQS(16+3,16) code is constructed by shortening the QS(18+3,18) code. The original QS code is implemented using s=3 multipliers and two 3-bit adders. Since Δ=2 bits are shortened, the implementation of the sQS requires a single shortened multiplier, two multipliers, and adders. Therefore, W(sQS(16+3,16))=sMUL(3,1,1)+2·MUL(3)+2·3=45.

However, the corresponding CpC(16+3,16) code constructed from sQS(8+3,8)+sQS(8+3,8), has different properties. The ground code sQS(8+3,8) is constructed by shortening the QS(12+3,12) code (s=2, Δ=4). The implementation of sQS(8+3,8) requires two shortened multipliers and two 3-bit adders. Therefore, W(sQS(8+3,8))=2·sMUL(3,1,1)+3=13, and the CpC code requires W(sQS(8+3,8)+sQS(8+3,8))=2·13+3=29 which minimizes the hardware complexity.

### 12. Optimization Algorithm

An efficient algorithm that finds the code that minimizes the implementation cost of a CpC code is now presented.

Every code is either a ground code or a CPC code. Every CpC code may be represented as a sum of two or more ground codes. Alternatively, every CpC may be represented as a sum of two codes of lower dimension, where a code of lower dimension may be a ground code or a CpC code.

Optionally, the total implementation cost of a particular CpC code is derived from the respective implementation costs of all the codes which are used to implement the CpC code (i.e. ground and/or CpC codes of lower dimension). The implementation cost is calculated for all possible combinations of codes.

The goal of the optimization algorithm is to find a code with minimal hardware complexity for a given set of parameters.

In one optional embodiment, a naïve algorithm goes over all possible ground codes and CpC codes for the given set of parameters using a brute force approach which has high time complexity as the number of possible codes grows exponentially as a function of k.

Alternately or additionally, as demonstrated in Algorithm 2, a recursive dynamic approach is used. For a given set of parameters, the algorithm goes over the k possible partitions of the information portion into two sub-vectors of smaller length k₁ and k₂. For k₁ and k₂ the codes with the best implementation cost are derived recursively (i.e. by running the same algorithm for the smaller values) and/or from previously calculated values that were generated when the algorithm was running on smaller parameters. Using these values, for each of the k partitions, the best code is derived, and by comparing their respective values the CpC code with minimal hardware complexity is found. This cost may also be compared to all possible ground codes with the same set of parameters. The code (ground or CPC) which has the lowest hardware complexity is derived from this comparison.

Optionally, the total implementation cost is calculated by assigning ‘weights’ to the hardware implementation of each code and, using this weight, choosing the code with the smallest weights for a given set of parameters.

Optionally, if a new or better implementation of one of a ground code is developed, the weights are recalculated according to the new implementation and the total implementation cost is recalculated with the new weights.

The weights assigned to the different ground codes may depend on the logic system being used. For instance, in the examples above the hardware cost for the ground was based on an implementation using XOR and AND gates. When a different logic system is used, the weights are computed accordingly and then the optimization may be rerun.

The respective weightings of the ground codes may also depend on the minimization criteria being used.

Optionally, the optimization costs are calculated recursively (e.g. as in Algorithm 2 below).

As noted above, CpC code and in particular C, is either a ground code or a CpC code, and a CpC code may be represented as a sum of two ground codes of smaller dimension, which themselves may be either a CpC code or ground code. Namely,

$${\underline{C}}^{< k , {Q}_{s} >} = {min}_{0 \leq i < k} ( W ( {\underline{C}}^{< k - i , {Q}_{s} >} ) + W ( {\underline{C}}^{< i , {Q}_{s} >} ) ) + min ( {r}_{1} , {r}_{2} ) XOR$$

where r₁ is the number of redundancy symbols of code C^{<k-i,Q}^{ₛ}^{>} and r₂ is the number of redundancy symbols of code C^{<i,Q}^{ₛ}^{>} if i≠0 and 0 otherwise. The overall number of redundancy symbols is r=max(r₁,r₂) and log(Qₛ)−1≤r₁,r₂≤log(Qₛ).

This property holds for any weight function.

An exemplary algorithm for finding optimal sets of ground codes is presented in Algorithm 2 below. Algorithm 2 may be adapted to find the codes that minimize the implementation cost for other sets of ground codes, other implementations of multipliers, etc.

Alg. 2 receives k and rₛ and returns the implementation cost of the code C=C^{<k,Q}^{ₛ}⁼²^{^{−r}}^{s>} denoted by W(C)=W(C^{<k,Q}^{ₛ}⁼²^{^{−r}}^{s>}) and a set of the parameters of its ground codes. The algorithm requires a table of irreducible polynomials and a table of the best puncturing sets Sₚ* in order to calculate the weight functions.

Algorithm 2: Algorithm GetBestCode

```
GetBestCode(k, rₛ):
Initialization: minW = ∞,
BestCPC = { }.
SetOfGroundCodes
= {PC(k + rₛ + 1, k), QS(k + rₛ + 1, k), TS(k + rₛ +1, k), QS(k
        + rₛ, k), sQS(k + rₛ + 1, k)}
\\ Find the ground code with minimal cost.
for each code in the set of ground codes do
  if Q̅(code) < 2^{-r}^{ₛ} then
    if W(code) < minW then
      minW = W(code)
      BestCPC = code
    end
  end
end
\\ Find the CpC code with minimal cost.
for 0 < j < k do
  (SetOfCodesA, W_{A}) = GetBestCode(k − J, rₛ)
  (SetOfCodesB, W_{B}) = GetBestCode(j, rₛ)
  W = W_{A} + W_{B} + rₛ + 1
  if W < minW then
    minW = W
    BestCPC = SetOfCodesA ∪ SetOfCodesB
  end
end
return (BestCPC,minW)
```

The puncturing sets were calculated as follows: for trinomials an optimal puncturing set was used [12]; for pentanomials with k<29 Alg. 1 was used.

Tables 4A-4B show the best puncturing vectors for 3<k<29 with 1≤r≤12. Each puncturing vector is a binary vector of length k and a Hamming weight r. The i'th coordinate in this vector is 1 if i∉Sₚ, and 0 otherwise. The puncturing vectors are in hexadecimal representation.

TABLE 4A

| | wt(π | π | | | | | | |
|---|---|---|---|---|---|---|---|---|
| k | (x)) | (x) | r = 1 | r = 2 | r = 3 | r = 4 | r = 5 | r = 6 |
| 3 | 3 | B | 1 | 3 | 7 | | | |
| 4 | 3 | 13 | 1 | 3 | 7 | F | | |
| 5 | 3 | 25 | 2 | A | B | F | 1F | |
| 6 | 3 | 43 | 1 | 3 | 7 | F | 1F | 3F |
| 7 | 3 | 89 | 4 | 24 | 26 | 36 | 37 | 3F |
| 8 | 5 | 11D | 2 | 5 | B | 17 | 2F | 3F |
| 9 | 3 | 211 | 8 | 88 | 8C | CC | CE | EE |
| 10 | 3 | 409 | 4 | 24 | 124 | 126 | 136 | 1B6 |
| 11 | 3 | 805 | 2 | A | 2A | AA | 2AA | 2AB |
| 12 | 5 | 1053 | 1 | 3 | 7 | F | 8F | 9F |
| 13 | 5 | 201B | 1 | 3 | 7 | F | 1F | 3F |
| 14 | 5 | 4443 | 1 | 3 | 421 | 423 | C23 | C63 |
| 15 | 3 | 8003 | 1 | 3 | 7 | F | 1F | 3F |
| 16 | 5 | 1100B | 800 | C00 | E00 | F00 | E81 | 1E81 |

TABLE 4B

| | wt(π | π | | | | | | |
|---|---|---|---|---|---|---|---|---|
| k | (x)) | (x) | r = 7 | r = 8 | r = 9 | r = 10 | r = 11 | r = 12 |
| 3 | 3 | B | | | | | | |
| 4 | 3 | 13 | | | | | | |
| 5 | 3 | 25 | | | | | | |
| 6 | 3 | 43 | | | | | | |
| 7 | 3 | 89 | 7F | | | | | |
| 8 | 5 | 11D | 7F | FF | | | | |
| 9 | 3 | 211 | EF | FF | 1FF | | | |
| 10 | 3 | 409 | 1B7 | 1BF | 1FF | 3FF | | |
| 11 | 3 | 805 | 2AF | 2BF | 2FF | 3FF | 7FF | |
| 12 | 5 | 1053 | 19F | FF | 1FF | 3FF | 7FF | FFF |
| 13 | 5 | 201B | 7F | FF | 4FF | 3FF | 7FF | FFF |
| 14 | 5 | 4443 | 23F | 27F | 2FF | 3FF | 7FF | FFF |
| 15 | 3 | 8003 | 7F | FF | 1FF | 3FF | 7FF | FFF |
| 16 | 5 | 1100B | 23F | FF | 2FF | 3FF | 7FF | FFF |

Alg. 2 was implemented using MATLAB for XOR=AND=1. The polynomials table for 2≤k≤16 was taken from MATLAB standard and for larger values of k from [23]. Whenever possible, π(x) is a trinomial; otherwise, it is a pentanomial.

Examples of CpC codes constructed using Alg. 2 for 2≤k≤10 and some Qₛ values are given in Table 5. The following ground codes were used: The QS, PC sQS and TS codes.

Each entry in the table contains the set of parameters of the ground codes which constitutes the CpC code and implementation cost of the CpC code. For example, for k=7 and Qs=2⁻¹ the optimal CpC code is the sum of sQS(5,3)+QS(5,4) which has an implementation cost of 6.

TABLE 5

| k\Qs | 2⁻¹ | 2⁻² | 2⁻³ | 2⁻⁴ |
|---|---|---|---|---|
| 2 | QS(3, 2) | | | |
| | 1 | | | |
| 3 | sQS(5, 3) | PC(6, 3) | | |
| | 2 | 18 | | |
| 4 | QS(5, 4) | sQS(7, 4) | PC(8, 4) | |
| | 3 | 5 | 33 | |
| 5 | QS(3, 2) + | sQS(8, 5) | PC(9, 5) | PC(10, 5) |
| | sQS(5, 3) | 10 | 42 | 52 |
| | 4 | | | |
| 6 | QS(7, 6) | sQS(9, 6) | sQS(10, 6) | PC(11, 6) |
| | 5 | 17 | 15 | 62 |
| 7 | sQS(5, 3) + | PC(6, 3) + | sQS(11, 7) | PC(12, 7) |
| | QS(5, 4) | sQS(7, 4) | 22 | 72 |
| | 6 | 26 | | |
| 8 | QS(9, 8) | sQS(11, 8) | sQS(12, 8) | sQS(13, 8) |
| | 7 | 13 | 31 | 29 |
| 9 | sQS(5, 3) + | sQS(12, 9) | PC(13, 9) | sQS(14, 9) |
| | QS(7, 6) | 18 | 77 | 38 |
| | 8 | | | |
| 10 | QS(11, 10) | sQS(8, 5) + | PC(8, 4) + | QS(15, 10) |
| | 9 | sQS(8, 5) | sQS(10, 6) | 49 |
| | | 23 | 52 | |

In summary, CpC coding may be used to construct high rate robust codes for any number of information symbols k, and any number of redundant symbols r. The CpC scheme uses several known ground robust codes to construct a new robust code with a low implementation cost. Efficient implementation of these codes was discussed and an exemplary algorithm for optimizing the hardware complexity over all possible CpC codes and ground codes was presented.

It is expected that during the life of a patent maturing from this application many relevant robust codes, separable robust codes, hardware devices, circuits, memories, and logic for combating attacks will be developed and the scope of the terms robust code, separable robust code, hardware device, circuit, memory, and error combatance logic is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### REFERENCES

[1] A. Barenghi, L. Breveglieri, I. Koren, and D. Naccache, “Fault injection attacks on cryptographic devices: Theory, practice, and countermeasures,” Proceedings of the IEEE, vol. 100, no. 11, pp. 3056-3076,2012.
[2] C. Paar, Implementation of cryptographic schemes. Ruhr University Bochum, 2015.
[3] M. G. Karpovsky, K. J. Kulikowski, and Z. Wang, “Robust error detection in communication and computational channels,” in Spectral Methods and Multirate Signal Processing. SMMSP'2007. 2007 International Workshop on, Citeseer, 2007.
[4] N. Admaty, S. Litsyn, and O. Keren, “Puncturing, expurgating and expanding the q-ary bch based robust codes,” in Electrical Electronics Engineers in Israel (IEEEI), 2012 IEEE 27th Convention of, pp. 1-5, November 2012.
[5] Y. Neumeier and O. Keren, “Robust generalized punctured cubic codes,” IEEE Transactions on Information Theory, vol. 60, no. 5, pp. 2813-2822,2014.
[6] M. Karpovsky and A. Taubin, “New class of nonlinear systematic error detecting codes,” Information Theory, IEEE Transactions on, vol. 50, no. 8, pp. 1818-1819,2004.
[7] R. Cramer, Y. Dodis, S. Fehr, C. Padro', and D. Wichs, “Detection of algebraic manipulation with applications to robust secret sharing and fuzzy extractors,” in Advances in Cryptology—EUROCRYPT 2008, pp. 471-488, Springer, 2008.
[8] Z. Wang and M. Karpovsky, “Algebraic manipulation detection codes and their applications for design of secure cryptographic devices,” in On-Line Testing Symposium (IOLTS), 2011 IEEE 17th International, pp. 234-239, IEEE, 2011.
[9] O. Keren and M. Karpovsky, “Relations between the entropy of a source and the error masking probability for security-oriented codes,” IEEE Transactions on Communications, vol. 63, no. 1, pp. 206-214,2015.
[10] H. Rabii, Y. Neumeier, and O. Keren, “Table of high rate robust codes with low implementation cost,” in www(dot)eng(dot)biu(dot)ac(dot)il/kereno/ongoing-projects/table-of-best-cpc-codes/, 2017.
[11] Z. Wang, “Nonlinear robust codes and their applications for design of reliable and secure devices,” PhD dissertation, Boston University, 2011.
[12] Y. Neumeier, Y. Pesso, and O. Keren, “Efficient implementation of punctured parallel finite field multipliers,” Circuits and Systems I: Regular Papers, IEEE Transactions on, vol. 62, no. 9, pp. 2260-2267, 2015.
[13] V. Tomashevich, Y. Neumeier, R. Kumar, O. Keren, and I. Polian, “Protecting cryptographic hardware against malicious attacks by nonlinear robust codes,” in Defect and Fault Tolerance in VLSI and Nanotechnology Systems (DFT), 2014 IEEE International Symposium on, pp. 40-45, IEEE, 2014.
[14] H. Rabii, Y. Neumeier, and O. Keren, “Low complexity high rate robust codes derived from the quadratic-sum code,” in 12th International Workshop on Boolean Problems, 2016.
[15] K. J. Kulikowski, Z. Wang, and M. G. Karpovsky, “Comparative analysis of robust fault attack resistant architectures for public and private cryptosystems,” in Fault Diagnosis and Tolerance in Cryptography, 2008. FDTC' 08. 5th Workshop on, pp. 41-50, IEEE, 2008.
[16] M. Karpovsky, K. J. Kulikowski, and A. Taubin, “Robust protection against fault-injection attacks on smart cards implementing the advanced encryption standard,” in Dependable Systems and Networks, 2004 International Conference on, pp. 93-101, IEEE, 2004.
[17] M. Karpovsky, K. J. Kulikowski, and A. Taubin, “Differential fault analysis attack resistant architectures for the advanced encryption standard,” in Smart Card Research and Advanced Applications VI, pp. 177-192, Springer, 2004.
[18] H. Wu, “Bit-parallel finite field multiplier and squarer using polynomial basis,” IEEE Transactions on Computers, vol. 51, no. 7, pp. 750-758, 2002.
[19] J. Guajardo, T. Güneysu, S. S. Kumar, C. Paar, and J. Pelzl, “Efficient hardware implementation of finite fields with applications to cryptography,” Acta Applicandae Mathematicae, vol. 93, no. 1, pp. 75-118, 2006.
[20] A. Halbutogullari and C. K. Koc. “Mastrovito multiplier for general irreducible polynomials,” IEEE Transactions on Computers, vol. 49, no. 5, pp. 503-518, 2000.
[21] H. Wu, “Montgomery multiplier and squarer for a class of finite fields,” IEEE Transactions on Computers, vol. 51, no. 5, pp. 521-529, 2002.
[22] X. Xiong and H. Fan, “GF (2n) bit-parallel squarer using generalised polynomial basis for new class of irreducible pentanomials,” Electronics Letters, vol. 50, no. 9, pp. 655-657, 2014.
[23] W. Stahnke, “Primitive binary polynomials,” Mathematics of Computation, vol. 27, no. 124, pp. 977-980, 1973.

1-26. (canceled)

27. A checker for detecting errors in a data string, said data string comprising an information portion and a redundancy portion, said information portion comprising at least two sub-strings, comprising:
a redundancy generator configured to:
generate a first redundancy word by encoding a first one of said sub-strings with a first separable robust code;
generate a second redundancy word by encoding a second one of said sub-strings with a second separable robust code; and
generate a composite redundancy word from said first and second redundancy words; and
an error detector associated with said redundancy generator, configured to flag an error when said redundancy portion of said data string differs from said composite redundancy word.

28. A checker according to claim 27, wherein said composite redundancy word is further generated from at least one additional redundancy word, each additional redundancy word being generated by encoding one of said sub-strings with a separable robust code.

29. A checker according to claim 27, further configured to output a data word in accordance with an error combatance logic in response to said flagging.

30. A checker according to claim 27, wherein said checker comprises a plurality of logic gates in a logic circuit.

31. A checker according to claim 27, wherein said checker is integrated into a hardware device.

32. A checker according to claim 31, wherein said hardware device includes at least one of: a memory, a logic circuit, an IC, a programmable logic element and a communication device.

33. A checker according to claim 27, further configured to perform at least one of:
read said data string from a memory;
read said data string from a register;
extract said data string from a data signal;
receive said data string through a data interface;
obtain said data string from nodes in a logic circuit; and
read said data string from a data bus in a logic circuit.

34. A method of encoding information strings, comprising:
in a hardware device:
inputting an information string comprising at least two sub-strings;
associating said sub-strings with codewords of respective separable robust codes, each of said associated codewords comprising a respective information word and a respective redundancy word; and
outputting a concatenated-codeword comprising an information portion comprising a concatenation of said respective information words and a redundancy portion generated from said respective redundancy words.

35. A method according to claim 34, wherein said redundancy portion is generated by addition over a finite field of said respective redundancy words within said codewords.

36. A method according to claim 34, wherein at least one of said separable robust codes comprises a non-quadratic sum (QS) code.

37. A method according to claim 34, wherein said separable robust codes comprise a same code.

38. A method according to claim 34, wherein at least two of said separable robust codes comprise different codes.

39. A method according to claim 34, wherein at least one of said separable robust codes comprises an error-correction code.

40. An encoder, comprising:
a codeword associator configured to:
separate an information string into at least two sub-strings:
associate a first one of said sub-strings with a codeword of a first separable robust code, said codeword of said first separable robust code comprising a respective information word and a respective redundancy word;
associate a second one of said sub-strings with a codeword of a second separable robust code, said codeword of said second separable robust code comprising a respective information word and a respective redundancy word; and
generate a redundancy portion from said redundancy words; and
a codeword outputter associated with said codeword associator, configured to output a concatenated-codeword comprising an information portion comprising a concatenation of said information words and said redundancy portion.

41. An encoder according to claim 40, wherein said redundancy portion is generated by addition over a finite field of said respective redundancy words within said codewords.

42. An encoder according to claim 40, wherein only one of said first and second separable robust codes comprises a quadratic sum (QS) code.

43. An encoder according to claim 40, wherein said first separable robust code and said second separable robust code comprise different codes.

44. An encoder according to claim 40, wherein said encoder comprises a plurality of logic gates in a logic circuit.

45. An encoder according to claim 40, wherein said encoder is integrated into a hardware device.

46. An encoder according to claim 40, further configured to perform at least one of:
read said information string from a memory;
read said data string from a register;
extract said information string from a data signal;
receive said information string through a data interface;
obtain said information string from nodes in a logic circuit; and
read said information string from a data bus in a logic circuit.
